(19) United States
(12) Patent Application Publication
(10) Pub. No.: US 2016/0180408 A1
(43) Pub. Date: Jun. 23, 2016

(54) SYSTEMS AND METHODS FOR A MULTI-CHANNEL, MULTI-TOUCH MARKETING SERVICE

(71) Applicant: MINDFIRE INTERNET SOLUTIONS, INC., Irvine, CA (US)

(72) Inventors: Reza Memarian, Irvine, CA (US); Manoochehr Asghari, Irvine, CA (US); David Rosendahl, Irvine, CA (US)

(21) Appl. No.: 14/935,041

(22) Filed: Nov. 6, 2015

Related U.S. Application Data
(63) Continuation of application No. 13/835,519, filed on Mar. 15, 2013, now abandoned.

(51) Int. Cl. G06Q 30/02

(52) U.S. Cl. CPC G06Q 30/0276; G06Q 30/0277

(57) ABSTRACT

The field of the invention relates to systems and methods for operation of an electronic marketing program service, and more particularly to systems and methods that provide an online user interface, a marketing language, and a marketing engine for multi-channel, multi-touch marketing campaigns. In an embodiment, the system includes an electronic marketing server system coupled to a public network and accessible to one or more users. The marketing server system includes a database that stores contact data associated with a plurality of marketing contacts, and marketing campaign data. The system is configured to provide a common user interface for designing and creating a multi-channel, multi-touch marketing campaign, and providing a Marketing Application Markup Language to a marketing engine for execution.

### CROSS-REFERENCE TO RELATED APPLICATIONS

This application is a continuation application of U.S. patent application Ser. No. 13/835,5198, filed Mar. 15, 2013, which is incorporated by reference herein in its entirety and for all purposes.

### FIELD OF THE INVENTION

The field of the invention relates to systems and methods for electronic marketing services, and more particularly to systems and methods that electronically provide multi-channel, multi-touch marketing services.

### BACKGROUND OF THE INVENTION

With the proliferation of Internet usage and advance in technologies, such as wireless communications, smart phones and their applications, the marketing field has been going through two major changes. First, consumers are changing the way they consume data and information. In response, new media and forms of communications are invented, evolving, and made available to reach customers and prospects. Media devices are also evolving. For example, online computer usage was once the advanced technology, but now tablets and smart phones are the new technology and may have already overtaken computer in number. With new media devices, like smartphones, new forms of sending information evolved from email, to text messages (or SMS, short message service), to social media interfaces, and to bursts of very short messages, such as Twitter messages. These changes make it difficult to anticipate new media and their uses, as well as to reach consumers at the right time, with the right message, via the right channel.

Most marketers adapt to the changes and technological advancement by using many different software applications and solutions to handle different media, e.g., email, text messages, social media, and print marketing. The marketers must go through the time consuming process of creating the marketing messages for each different medium. In such instances, every time there is a small change in the marketing message, the marketers must revise the individual messages in each different medium. This process is not only difficult to manage, it is also costly, and may cause unnecessary delays for the marketing messages to reach the intended consumers. Accordingly, improved systems and methods for one solution to bring these media together to allow the marketers to orchestrate and manage multi-channel, multi-touch campaigns from one common interface may be desirable. An example of such interface is MindFire Studio (www.mindfirestudio.com).

### SUMMARY OF THE INVENTION

The field of the invention relates to systems and methods for operation of an electronic marketing program service, and more particularly to systems and methods that provide an online user interface, a marketing language, and a marketing engine for multi-channel, multi-touch marketing campaigns.

In an embodiment, the system includes an electronic marketing server system coupled to a public network and accessible to one or more users. The marketing server system includes a database that stores contact data associated with a plurality of marketing contacts, and marketing campaign data. The system is configured to provide a common user interface for designing and creating a multi-channel, multi-touch marketing campaign, and providing a Marketing Application Markup Language to a marketing engine for execution.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1a is an exemplary diagram of a marketing system according to an embodiment of the present invention.

FIG. 1b is an exemplary diagram of a marketing server system according to an embodiment of the present invention.

FIG. 2 is an exemplary common user interface according to an embodiment of the present invention.

FIG. 2a is an exemplary user interface for defining a marketing contact list according to an embodiment of the present invention.

FIG. 3 is another exemplary common user interface according to an embodiment of the present invention.

FIG. 4 is another exemplary common user interface according to an embodiment of the present invention.

FIG. 5 is another exemplary common user interface according to an embodiment of the present invention.

FIG. 6 is another exemplary common user interface according to an embodiment of the present invention.

FIG. 6b is another exemplary common user interface according to an embodiment of the present invention.

FIG. 7 is another exemplary common user interface according to an embodiment of the present invention.

FIG. 8 is another exemplary common user interface according to an embodiment of the present invention.

FIG. 8a is an exemplary MAML according to an embodiment of the present invention.

FIG. 8b is an exemplary marketing workflow according to an embodiment of the present invention.

FIG. 8c is another exemplary MAML according to an embodiment of the present invention.

FIG. 8d is another exemplary MAML according to an embodiment of the present invention.

FIG. 8e is another exemplary MAML according to an embodiment of the present invention.

FIG. 8f is another exemplary marketing workflow according to an embodiment of the present invention.

FIG. 8g is another exemplary MAML according to an embodiment of the present invention.

FIG. 8h is another exemplary marketing workflow according to an embodiment of the present invention.

FIG. 8i is another exemplary MAML according to an embodiment of the present invention.

FIG. 8j is another exemplary MAML according to an embodiment of the present invention.

FIG. 9 is an exemplary user interface for displaying measurements and reports of a marketing campaign according to an embodiment of the present invention.

FIG. 10 is an exemplary process of a marketing system according to an embodiment of the present invention.

FIG. 10a is another exemplary process of a marketing system according to an embodiment of the present invention.

FIG. 11 is another exemplary process of a marketing system according to an embodiment of the present invention.

FIG. 12 is another exemplary process of a marketing system according to an embodiment of the present invention.

FIG. 13 is another exemplary process of a marketing system according to an embodiment of the present invention.

FIG. 14 is another exemplary process of a marketing system according to an embodiment of the present invention.

FIG. 15 is another exemplary process of a marketing system according to an embodiment of the present invention.

### DETAILED DESCRIPTION OF THE PREFERRED EMBODIMENTS

### Preferred Systems

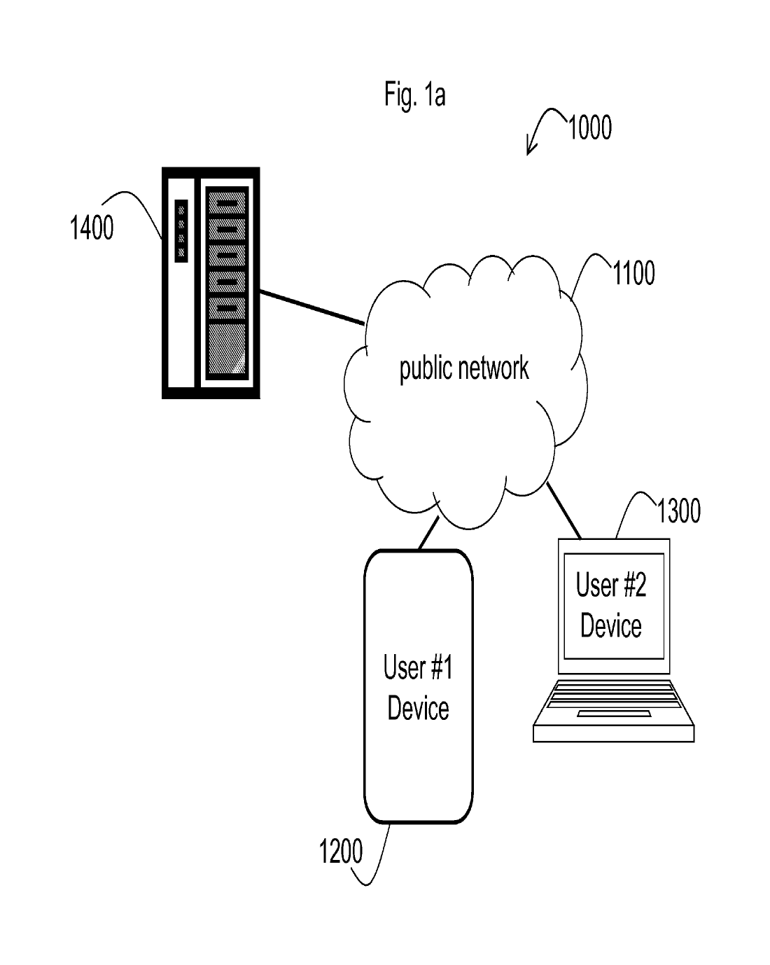

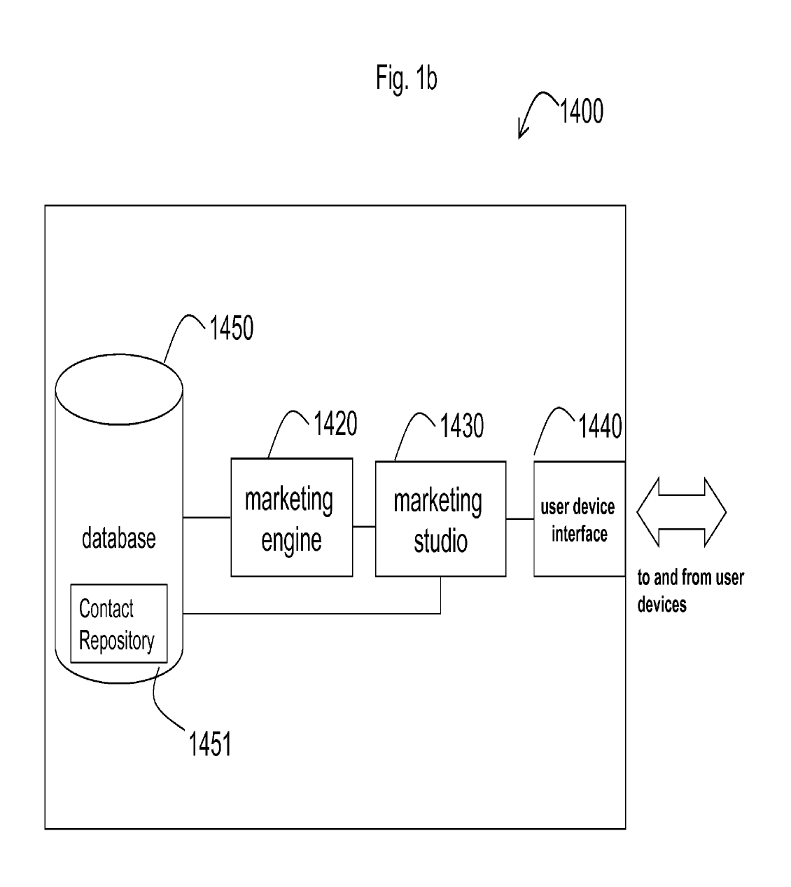

Turning to FIG. 1a, a computer-based marketing system 1000 according to an embodiment of the present invention is shown. The system 1000 generally includes a marketing server system 1400, which may be distributed on one or more physical servers, each having processor, memory, an operating system, and input/output interface, and a network interface all known in the art, and a plurality of end user computing devices 1200/1300 coupled to a public network 1100, such as the Internet and/or a cellular-based wireless network. The marketing server system 1400 may also be cloud-computing based (or cloud-based).

Turning to the marketing server system 1400, an exemplary embodiment is shown in FIG. 1b. Generally, a marketing server system 1400 (which may be cloud-based) includes a marketing engine 1420 and a marketing studio 1430 designed to assist users of the marketing server system 1400 to design, build, define automation, manage, and analyze the performance of multi-channel, multi-touch marketing programs using a common interface. A marketing program utilizes multi-channel, cross-media, multi-touch media to reach consumers. Examples of the channels or media utilized include Outbound media like direct mail, SMS text messages, Email, various social media like Twitter and Facebook, and so on. Examples of the channels or media utilized also include Inbound media like online microsites or landing pages, other social media like Facebook and Twitter, and so on. The marketing studio 1430 includes common graphical user interfaces that enable the users to plan, build, and manage marketing workflows. The user uses the marketing studio 1430 via user device interfaces 1440 to create the workflow and configure every marketing element, which falls into one of three categories: Target Audiences, Outbounds, and Inbounds. As the user constructs their marketing workflow in the studio 1430, the marketing server system 1400 creates Marketing Application Markup Language (MAML) program. The marketing engine 1420 receives the MAML through Representational State Transfer (or REST) based APIs, or Simple Objective Access Protocol (SOAP) based APIs, stores it in a database 1450 (also referred herein and Campaign database and Account database), and parses the MAML into three categories (Target Audiences, Outbounds, and Inbounds) and submits them to the appropriate plug-ins according to a marketing schedule. The plug-ins distribute the contact information and their behavioral data to the appropriate cloud-based application, which is configured to communicate with third-party service providers (e.g., Facebook, Salesforce.com, and the like.) for execution.

MAML generally describes a marketing program. A program may contain one or more campaigns. A campaign is comprised of one or more elements, which fall into one of three categories: Outbound, Inbound, or Target Audience. A campaign also contains the definition of how elements are connected. Some elements may have a sub-workflow comprised of child elements. A campaign defines how certain Target Audience segments are touched by one or more Outbound or Inbound media, at predetermined schedules, and which contact behaviors trigger subsequent actions (Outbounds), and how those contact behaviors are weighted via goals, scores, or cost, and so on. The content for all Outbound and Inbound media is included in the MAML. In addition, the MAML also defines how the Outbound's and Inbound's content is personalized for the intended contact. Within the MAML for each Outbound or Inbound element, the MAML can specify which cloud-based application (app) is required for execution. MAML can also describe reports that can be generated for a campaign. MAML also contains attributes that describe how multiple users collaborate within a program. MAML can be extended to contain additional information that can be used by a third-party application to render a design interface, or other purposes. In the MAML, a marketing program is comprised of one or more campaigns and rule groups.

A user may create and/or access one or more marketing account. Each user has one or more assigned role(s), with each role containing a set of account-level permissions. Each account has a centralized Contact Repository 1451, stored in the database 1450, which is used by applicable marketing program within that account. Users can add any number of custom Fields to their Contact Repository 1451 to hold account-specific information about their contacts. As programs are executed, contact behaviors are collected and persisted to enrich the contact's profile stored in the Contact Repository 1451. This information can then be used to improve subsequent campaigns to personalize and make follow-up communication more specific to individual contact behavior. The Contact Repository 1451 can be initially populated by contacts interacting with Inbound elements, which get added as new contacts, uploaded or manually entered by users, or synced from third-party customer relationship management (CRM) applications (like Salesforce.com), and so on. When contacts are added, they are intelligently de-duped using user-controlled rules. Contacts may be edited, updated, flagged as deleted using tools provided by the marketing studio's 1430 Contact Management section (not shown).

Each marketing element has an associated set of events, which may have one or more attributes (e.g., bulk, child element, hooked in a trigger, and so on). Events with bulk attribute are events that happen for activities at the engine or app level. Events with the child element attribute are events related to elements in a sub-workflow, such as Microsite Pages. Events with the Hooked in a Trigger attribute are events that a trigger can monitor to fire a subsequent Outbound.

Events are used in at least the following ways:

1) Behavioral filtering, which allows the user to specify certain contact behaviors, used in rules, contact lists, schedule run-time filters, workflow decision making, and so on

2) Tracking, for Reporting and Analytics

3) Associating score, goal, and cost to specific events, or to more detailed activities such as links in an email or microsite page

4) Firing triggers.

All marketing execution is fired based on a schedule, defined in each Outbound or Inbound element. Schedule can be a specific date and time in the future (either explicitly stated or read from a contact's profile), an off-set based from an event-related point, or recurring at a predetermined frequency. All schedules can be configured using a designated time zone. Inbound and Outbound element's content may be personalized by at least one of three types of variables: Contact Profile-based, Rule-based, and Smart variables. Contact Profile-based variable displays information from a contact's standard or custom fields. Rule-based variable displays content based on a rule group. Smart variable is used to retrieve behavioral data, system level data, and other platform functions.

Every program may contain one or more rule groups. A rule group is comprised of one or more rules. A rule uses a contact's profile and past behavior to conditionally personalize an element's content. In order to do that, the user associates one or more variables to each rule group, and sets the content for each variable's variations. The user then places these variables in either Outbound or Inbound content.

Filters are used to specify a segment of contacts, or assess whether (or not) contacts have certain profile characteristics, and/or certain Behavior. Filters are used in at least the following areas:
1) Target Audiences, including contact lists and triggers
2) Rules, to vary a variable's content
3) Decision flows, like element sub-workflow decision-making (e.g., Microsite pageflow)
4) Schedule run-time filters, which assess whether or not a schedule should be executed at run-time.

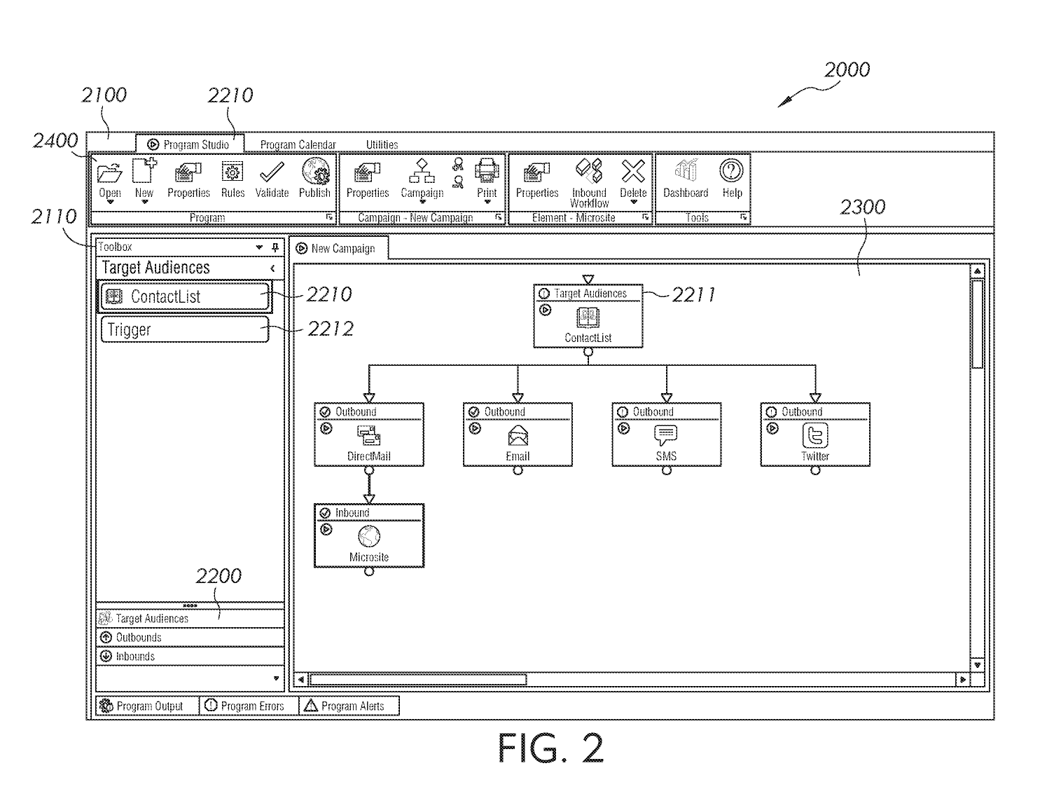

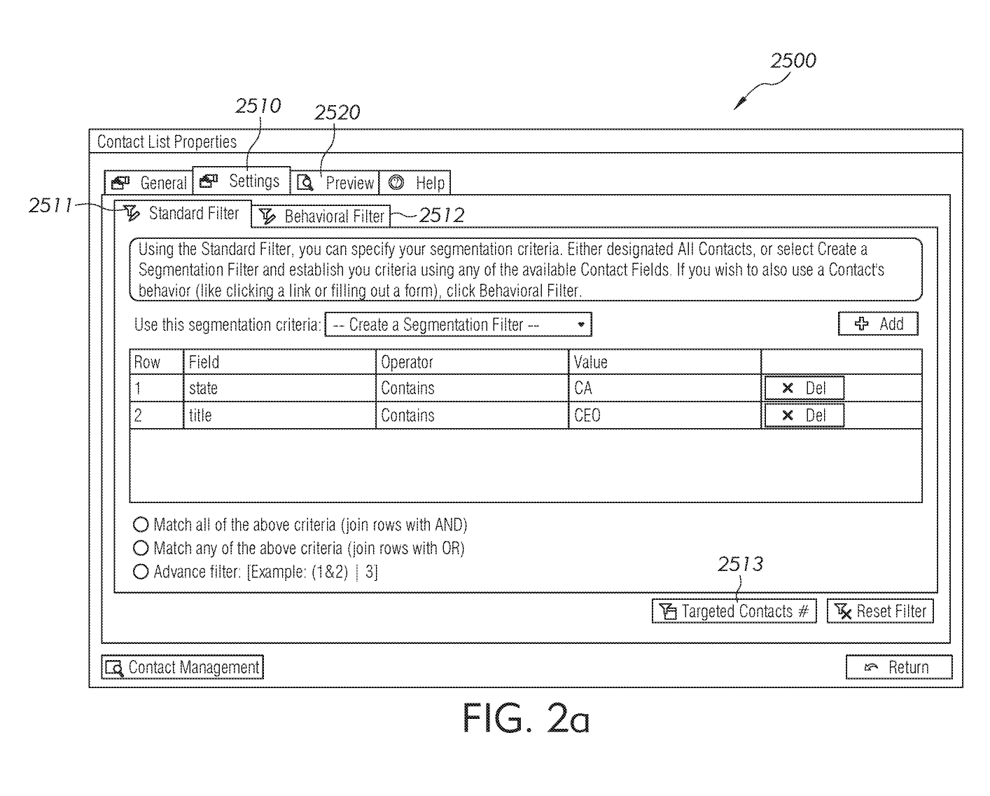

There are two types of filters: standard and behavioral. Through the standard filter (2511 in FIG. 2a), the user can select contacts from the Contact Repository 1451 using one or more fields in the Contact Repository 1451, e.g., first and/or last name, address, title, gender, state, city, email, and so on. Through the behavioral filter (2512 in FIG. 2a), the user can select contacts from the Contact Repository 1451 based on behavioral patterns. These behaviors can be based on contacts achieving a goal, performing an event, achieving a certain score, providing data in a form, having certain session attributes (e.g., the type of browser they're using), and so on. These behaviors can be selected from any program, or a specific program, campaign, element, or child element. In addition, the user can specify the last behavior, any behavior, or behavior in a certain child element.

Turning to FIG. 2, an exemplary user interface 2000 on a user device 1200/1300 is shown. The user interface 2000 is the Marketing Studio client on the user device 1200/1300, e.g., a downloaded webpage, a mobile application, or a thin client application, configured to operatively communicate with the marketing server system 1400 via the public network 1100. The Marketing Studio client is ultimately used to generate MAML, which is provided to the marketing engine 1420 for execution. The user interface 2000 on a user device 1200/1300 uses a drag-and-drop feature, and is configured to present an intuitive way for the users to design a marketing campaign. The user interface 2000 includes a Ribbon Bar 2100. Under the Program Studio tab 2210 of the Ribbon Bar 2100, a user may create a new marketing program, or open an existing marketing program, which is displayed on the canvas 2300.

The user interface 2000 also includes a Toolbox window 2110. The Toolbox contains three tabs, one for Target Audiences, Outbounds, and Inbounds. In the Toolbox window 2110, after the user selects the Target Audiences tab 2200, the Toolbox window 2110 shows a Contact List 2210 and a Trigger 2212. The user may select and drag one or more Contact List 2210 to the campaign canvas 2300 to create a targeted audience for the marketing campaign. This creates one or more Target Audiences element 2211.

A Contact List 2210 is a subset of the account's Contact Repository 1451. The user configures a Contact List 2210 by selecting the Target Audiences element 2211 and clicking on the Properties command icon in the Ribbon Bar 2400, or by double-clicking on the Target Audiences element 2211, which causes the user interface 2500 to be displayed, as shown in FIG. 2b. The user interface 2500 enables the user to configure a contact list using Standard Filter 2511, or Behavioral Filter 2512. The user selects the Targeted Contacts button 2513 to view how many contacts are included in the contact list being created. The user selects the Preview button 2520 to view the contacts, e.g., name, title, and recent activity of the contacts.

Turning to FIG. 2a, an exemplary user interface 2500 for setting the properties of a Contact List 2210 is shown. The user selects the Properties icon in the Program Studio tab 2210 (FIG. 2) to have user interface 2500 displayed. The user then sets The Standard Filers 2511 and Behavioral Filers 2512 (as described above).

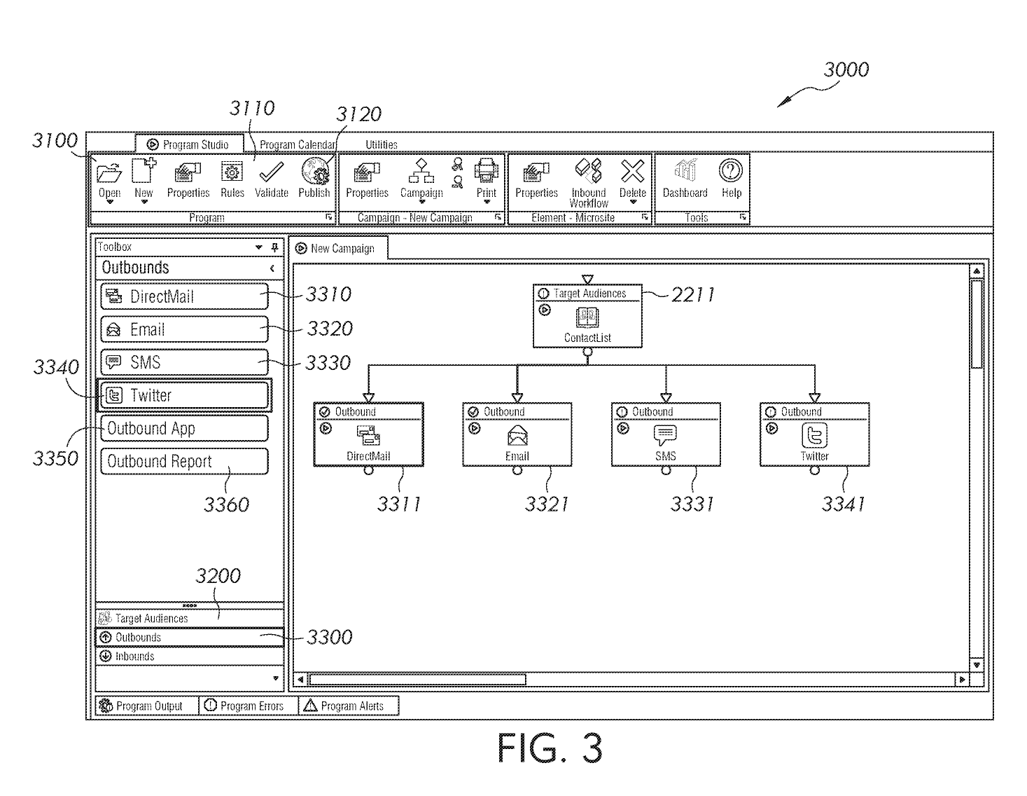

Turning to FIG. 3, an exemplary user interface 3000 is shown. When the user selects the Outbounds tab 3300 in the Toolbox window 2110, the user interface 3000 displays one or more marketing media (or media types) that can be used to intelligently send personalized marketing content to the target audiences in the marketing campaign. The media may include, e.g., DirectMail 3310, Email 3320, SMS 3330, Twitter 3340, and Generic Outbound App 3350, Generic Outbound Report 3360, and so on. The list of the media may be extended as new media are supported, evolved, or invented. The user may select and drag one or more desired media to the campaign canvas 2300. For example, to create a direct mail campaign targeted at the Target Audiences 3210 (as selected in FIG. 2), the user selects and drags the DirectMail medium 3310 from the Toolbox window 2110 to the campaign canvas 2300. This creates the Outbound DirectMail element 3311. The user then connects the Outbound DirectMail element 3311 to the Target Audiences element 3210. In the same manner, the user may select and drag the Email medium 3320, the SMS medium 3330, the Twitter medium 3340, and so on, to the campaign canvas 2300. This creates the Outbound Email element 3321, the Outbound SMS element 3331, the Outbound Twitter element 3341, and so on. The Outbound elements may be sent to the Target Audiences 3210 to invite the targeted audiences to respond via one or more inbound media or channels to be described below. The user then connects the Outbound Email element 3321, the Outbound SMS element 3331, the Outbound Twitter element 3341, and so on, to the Target Audiences element 2211 (created in FIG. 2).

After an Outbound element has been created, the user double clicks on the element as shown in the campaign canvas 2300 to provide marketing information that may be used with the Outbound element. For example, when the user double clicks on the Outbound SMS element 3331, the user interface 3000 displays a pop-up window (not shown) where the user specifies the desired SMS account to send from, a text message to send to the contact, and so on. Or when the user double clicks on the Outbound Email element 3321, the user interface 3000 displays a pop-up window (not shown) where the user may provide a subject title, a HTML and/or text message, and so on.

When an element is created in the campaign canvas 2300 but has an error, alert or warning, the user interface 2000 provides corresponding error, alert, or warning indicia. For example, an error or alert may include an incomplete contact list filter, undefined social media account, and so on. The user may also select and delete an element in the campaign canvas 2300 using the Delete command icon in the Ribbon Bar 3100 before publishing. At any time, the user may use the Validate command icon 3110 or the Publish command icon 3120 in the Tool bar 3100 to verify that the marketing campaign design in the campaign canvas 2300 has no error. As a result, a multi-channel, multi-touch marketing campaign is created. The Publish command 3120 submits the MAML to the marketing engine 1420. The marketing engine 1420 parses the MAML into three categories: Target Audience, Inbound, and Outbound. Based on these categories and their attributes (e.g., events, schedules, and so on) the marketing engine 1420 processes the MAML categories (e.g., personalizing content) and their associated data. When the date for an element is ready, the marketing engine 1420 calls one or more relevant plug-ins, and subsequently the one or more plug-ins contact the appropriate cloud-based application to execute that element.

Once a marketing campaign has been published, the Publish command icon 3120 is replaced by a Collaborate command icon (not shown), which the user selects to enable editing (check-out) of the program, campaign, or an element. The Collaborate command may also be used to enable other users of the marketing server system 1400 to view and edit the marketing campaign via “Share”. All edits to the marketing campaign are logged. The user may undo previous edits and revert the marketing campaign to the last published version.

Collaboration allows multiple users to work together to create a marketing program. A program owner can share a program, and for each user, set various permissions for the program, campaign, or element (for example, define program permissions, such as edit, view, calendar view, report view, and so on). Collaboration is available at the program, campaign, and element level to allow users to work together without impacting one another. If a user has edit permission, he can enable editing, which allows him to make changes, and then publish the edits to make those changes live on the marketing server system 1400.

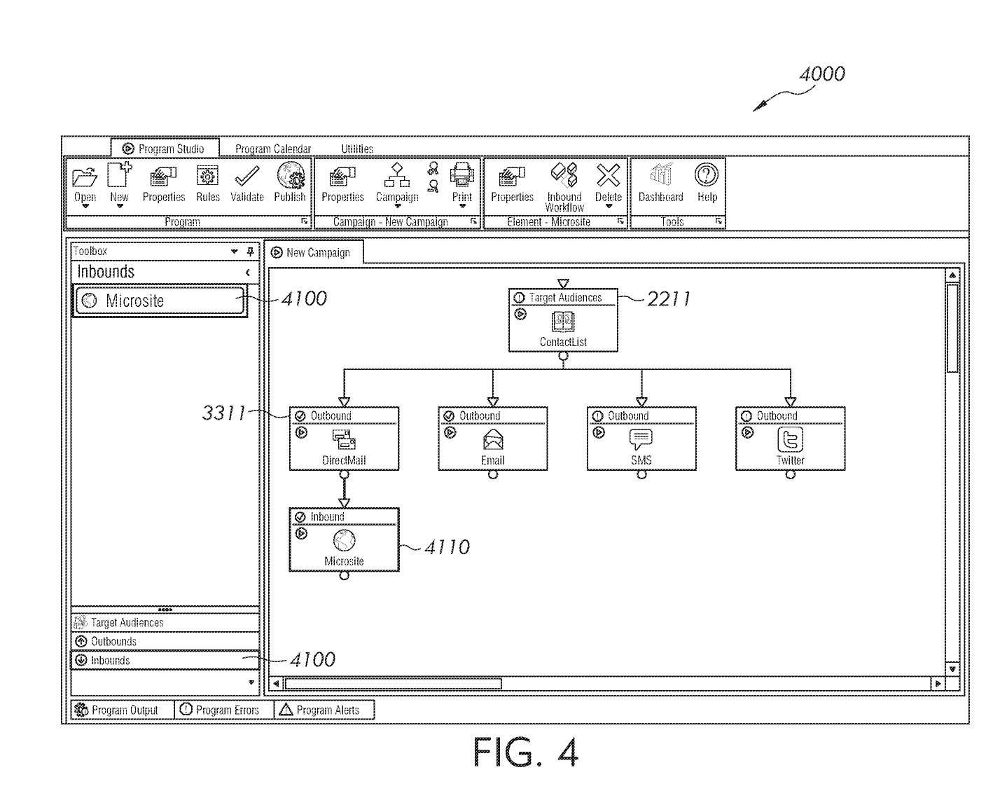

Turning to FIG. 4, an exemplary user interface 4000 on a user device 1200/1300 is shown. When the user selects the Inbounds tab 4100 in the Toolbox window 2110, the user interface 4000 displays one or more marketing media or channels that can be used in the marketing campaign to capture data regarding contact behavior as they interact with the marketing campaign. This Inbound data can be capture implicitly (e.g., capturing the contact's clickstream, and so on), or explicitly (e.g., the contact providing form data in a browser, voice commands using an IVR system, and so on). Different media may capture different types of information based on their nature. The media may include, e.g., Microsite medium 4100, Facebook, SMS, call center, third party website, search, YouTube, and so on. The list of the media may be extended as new media are supported, or invented. The user may select and drag one or more desired media to the campaign canvas 2300. For example, to use a Microsite to capture response from an Outbound Direct Mail piece, the user selects and drags the Microsite medium 4100 to the campaign canvas 2300. This creates the Microsite element 4110. The user may then connect the Microsite element 4110 to one or more Outbound elements. For example, the user connects the Microsite element 4110 to the DirectMail element 3311 to indicate that the targeted audiences of Target Audiences element 2211 may respond using Microsite element 4110 via information provided in the DirectMail element 3311. The user may also select and delete an Inbound element in the campaign canvas 2300 using the Delete command icon in the Tool bar 3100.

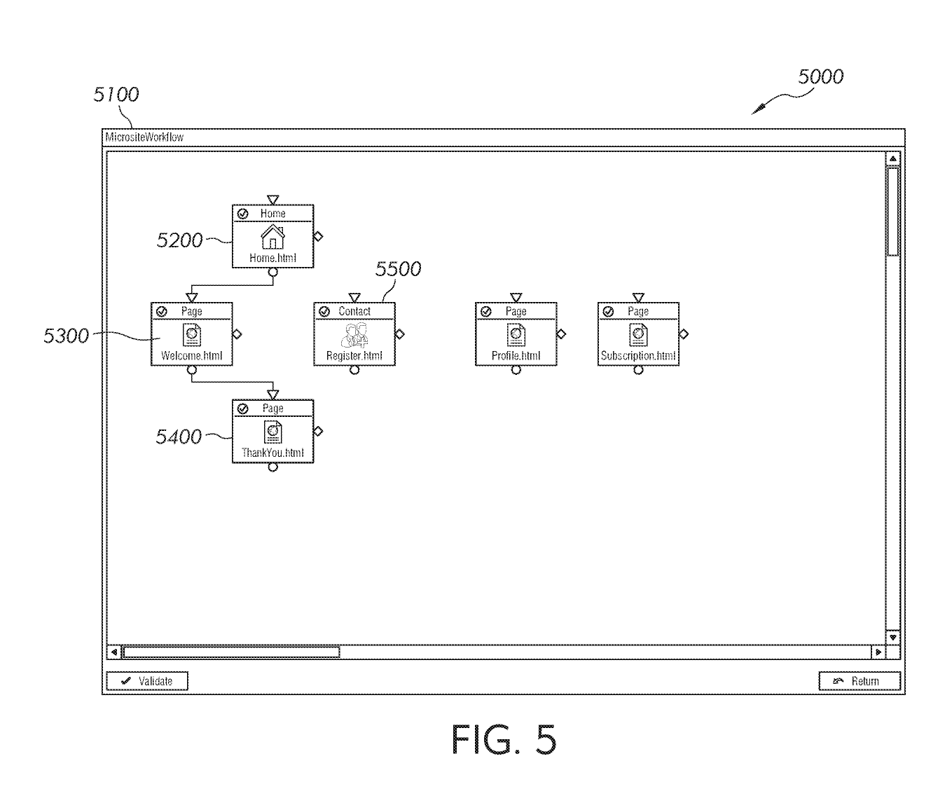

Turning to FIG. 5, an exemplary user interface 5000 on a user device 1200/1300 is shown. The user interface 5000 may be used for an Inbound or Outbound element that includes further definition, e.g., subworkflow, containing one or more child elements. The child elements may have different options/behaviors depending on the media they belong to. In addition, the subworkflow can include conditional flows, based on contact behavior. For example, in the case of a microsite, its child elements are pages. Thus, when the user selects an Inbound Microsite element in the campaign canvas 2300 and the Inbound Workflow command icon in the Tool bar 3100, the user may define a workflow for that Inbound Microsite comprising a variety of microsite pages, like a Home page 5200, a Welcome page 5300, a ThankYou page 5400, and so on. It may also comprise a Register page 5500.

Every Inbound has an Inbound Touch Point (not shown) that can be used to link contacts from the Outbound to the Inbound. The marketing server system 1400 tracks which contact visited the Inbound, and tracks which link was clicked in an Outbound (e.g., in the case of an email), or which barcode was scanned on a Direct Mail piece, and so on. Each Inbound also has a schedule (not shown), defining the start and end period for the Inbound, and an Events section similar to any Outbound media.

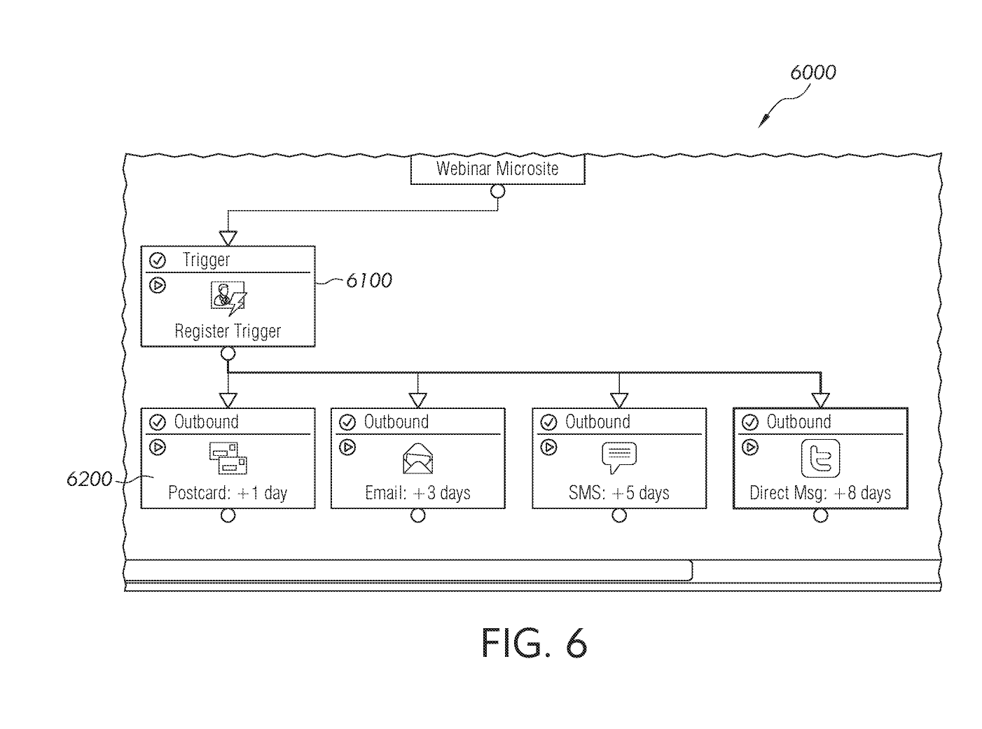

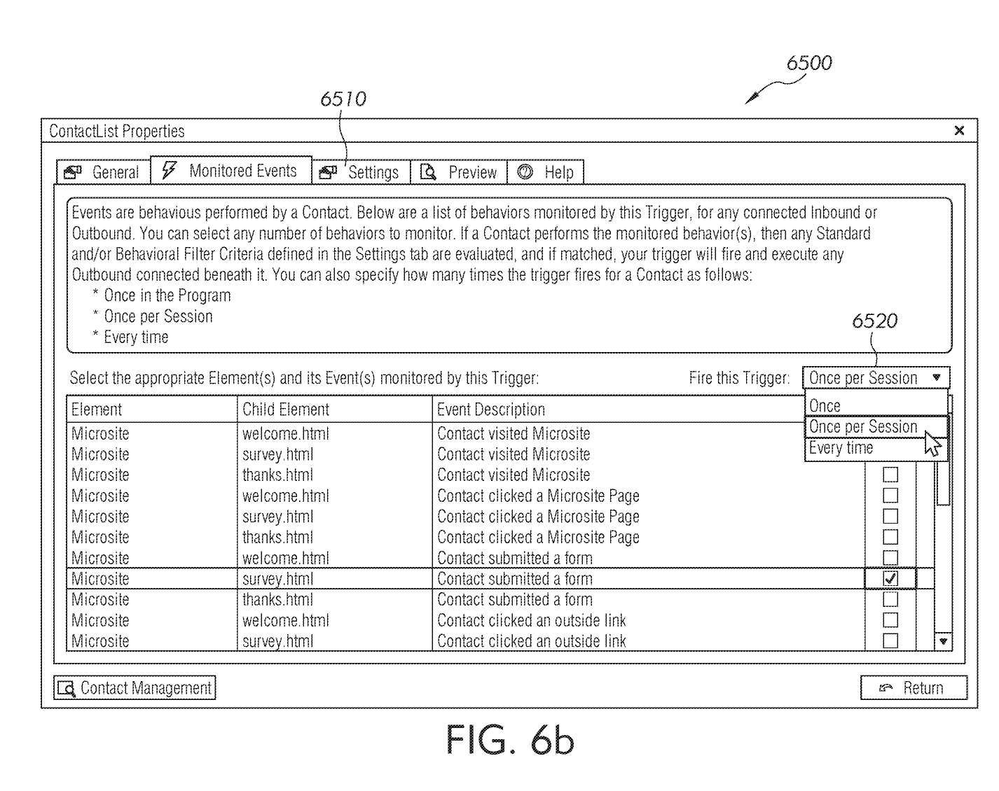

Turning to FIG. 6, an exemplary user interface 6000 on a user device 1200/1300 is shown. The user can use a Trigger 6100 to monitor contact behavior (captured via events) taking place in an Outbound or Inbound, and serves to fire another action. This action can be one or more connected Outbounds, which again can be connected to other Triggers 6100, and the process can repeat recursively. For example, a Form Submit event 5500 (FIG. 5) performed by a contact via an Inbound Microsite (FIG. 4) may fire a connected Trigger 6100. To define one or more campaign actions to be executed as the result of the Trigger 6100, the user may select and drag one or more Outbound media from the Toolbox window 2110 to the campaign canvas 2300. For example, the user may select and drag a Direct Mail medium, an Email medium, an SMS medium, and a Direct Msg medium from the Toolbox window 2110 to the campaign canvas 2300. Each Outbound element may also be defined to take place over time. For example, the Postcard Outbound 6200 is defined to take place 1 day (“+1 day”) after the Trigger 6100 takes place, and so on.

A trigger may be defined in an exemplary user interface as shown in FIG. 6b. The user interface 6500 is displayed when the user double-clicks on a Trigger 6100 element in the campaign canvas 2300. Using the interface 6500, the user may define a list of one or more behaviors monitored by the selected trigger. The monitoring may be specific as only applicable to a subset of the contact list. The subset is defined using the Settings tab 6510. This definition process is similar to that described above in the process of creating a contact list. The trigger may also be set up to occur only once, once per session, or everytime.

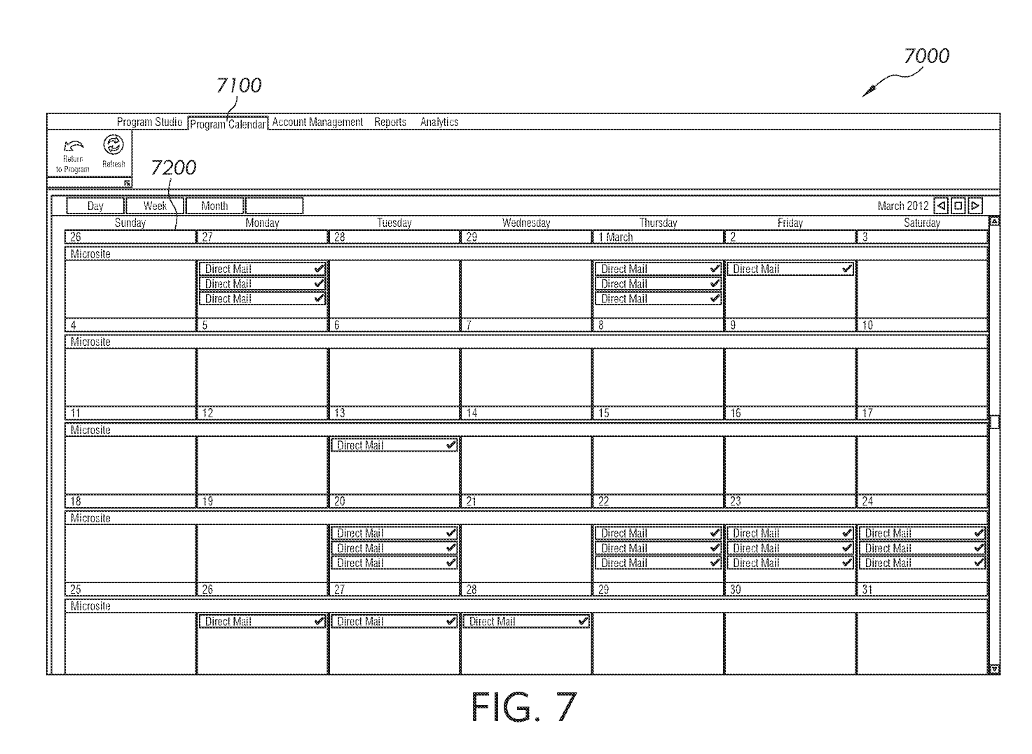

Turning to FIG. 7, an exemplary user interface 7000 on a user device 1200/1300 is shown. The user interface 7000 is displayed after the user selects the Program Calendar tab in the menu banner 2100. The program calendar shows all non-triggered Outbound schedules, and Inbound schedules. The calendar displays Outbound and Inbound schedule duration, and in the case of the Outbound, shows which schedules (including repeat schedules) have been executed and related schedule information. The status is visually displayed for executed schedules, those that are in process, and those that failed. In addition, one or more “Repeat” schedules are shown if the schedule is set to repeat. The user can select to see activities by Day, Week, Month or Timeline.

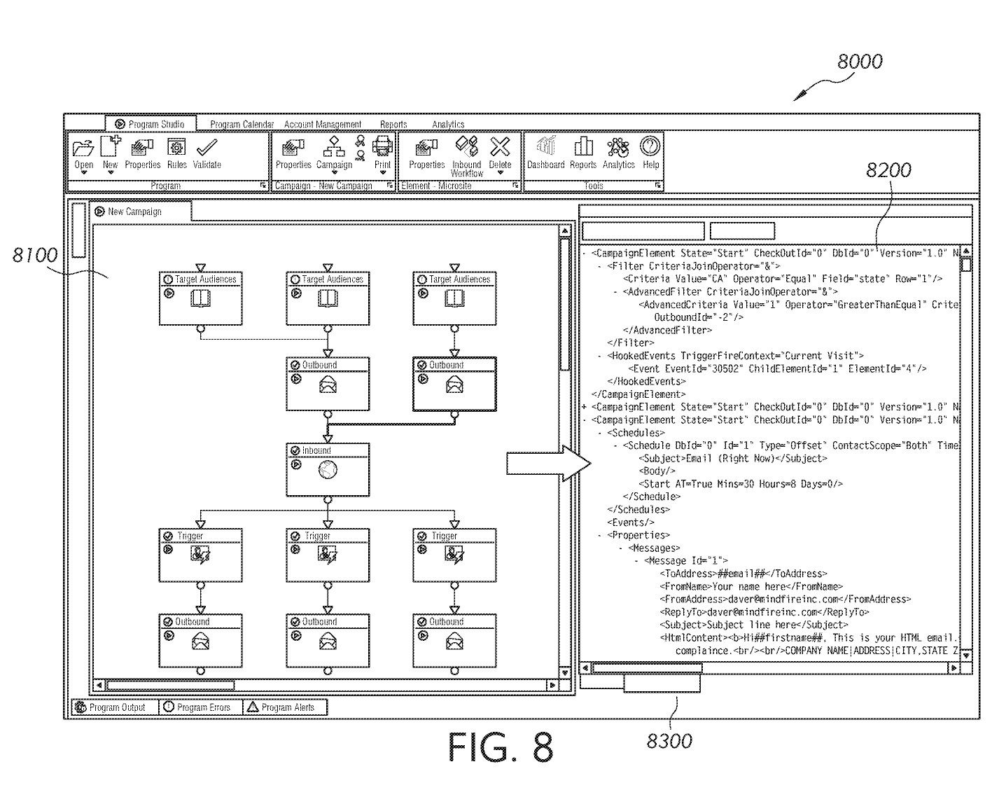

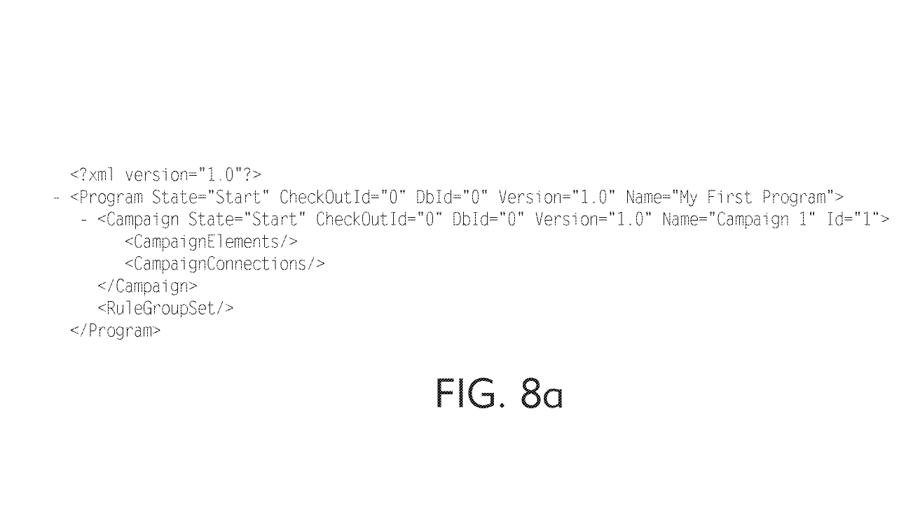

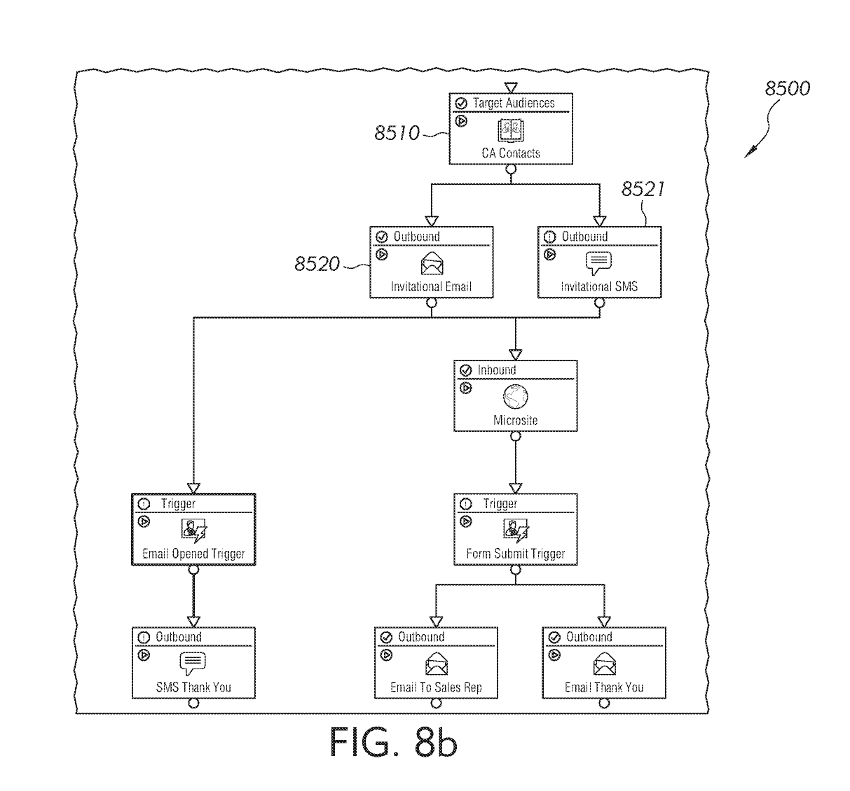

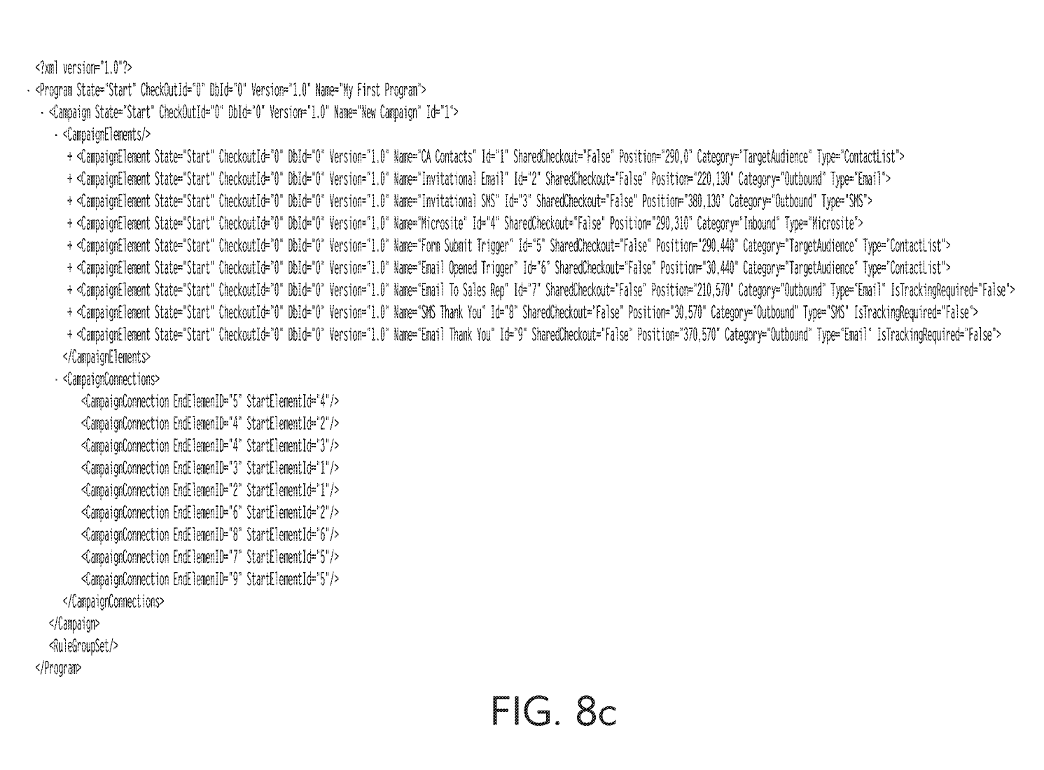

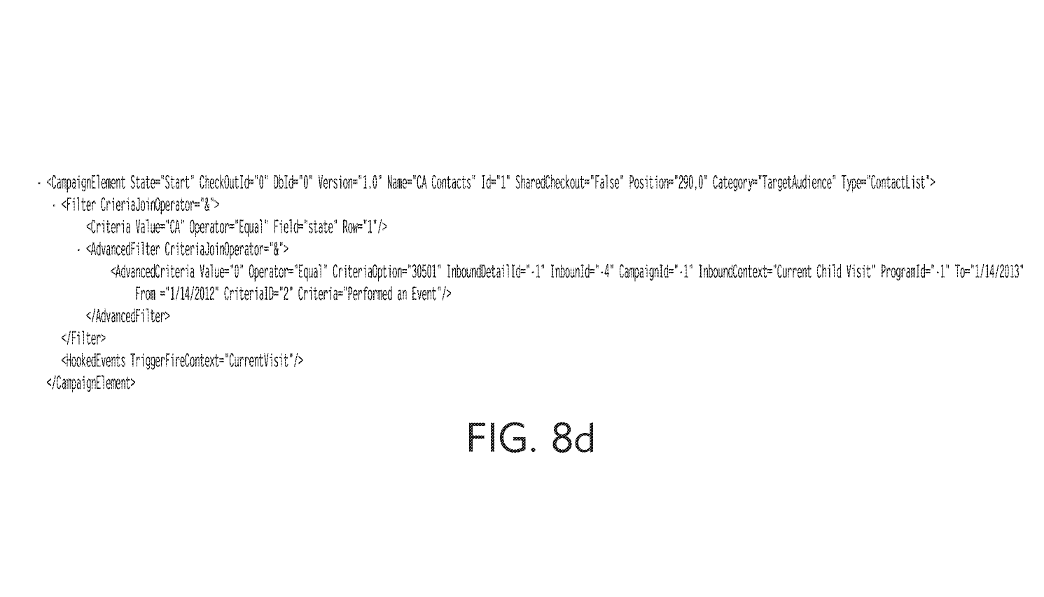

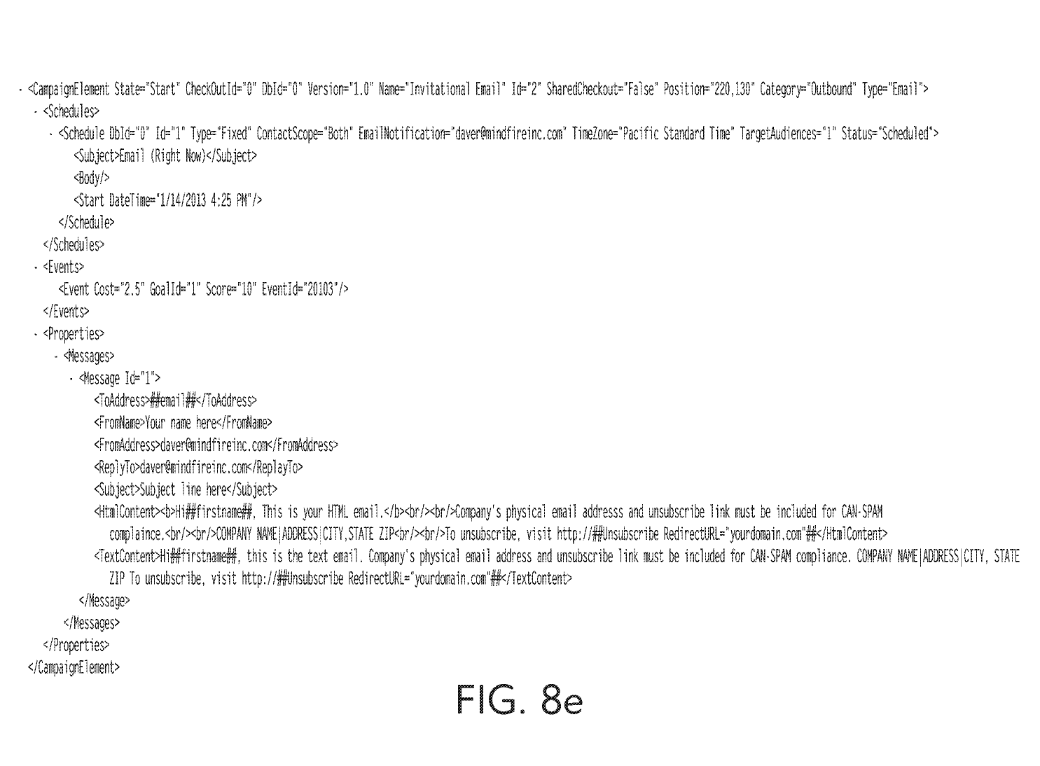

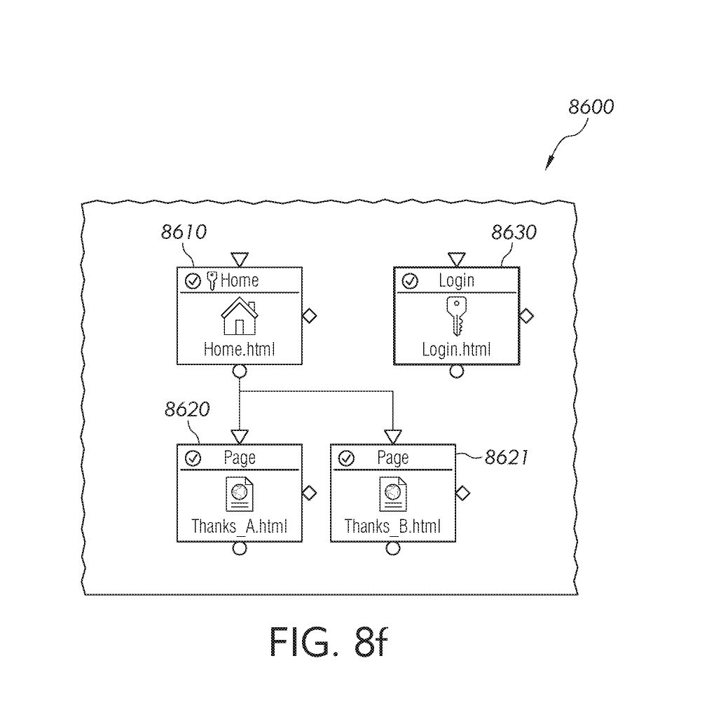

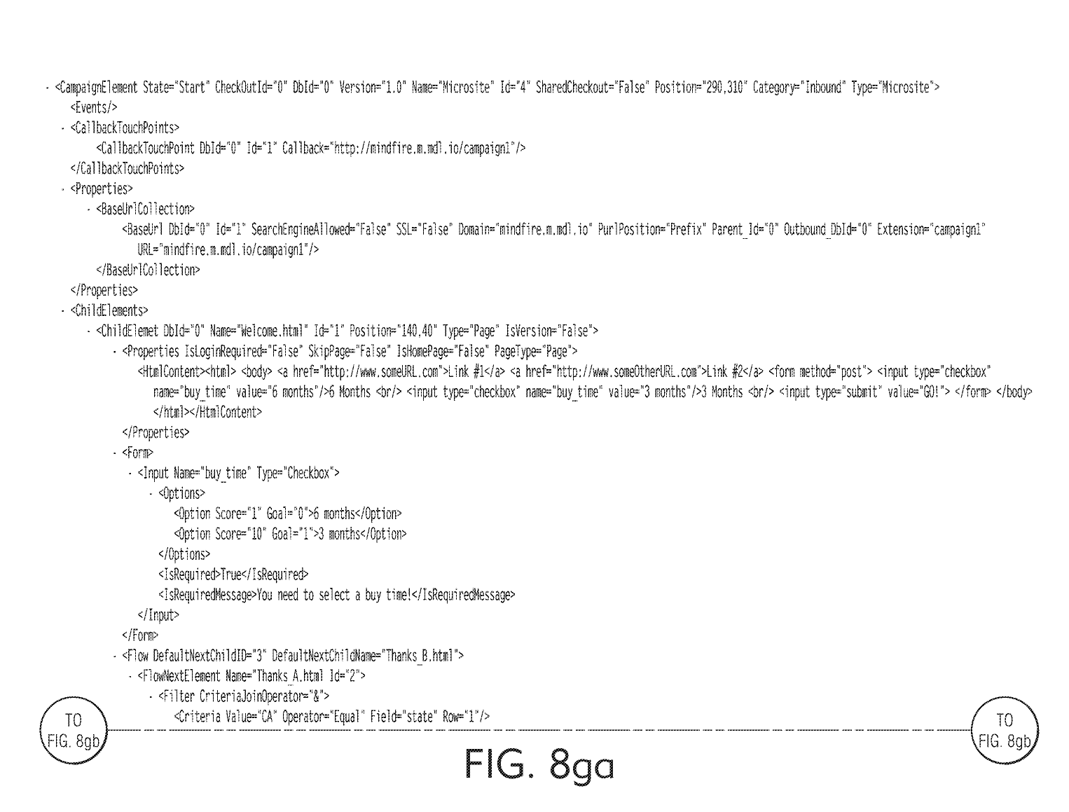

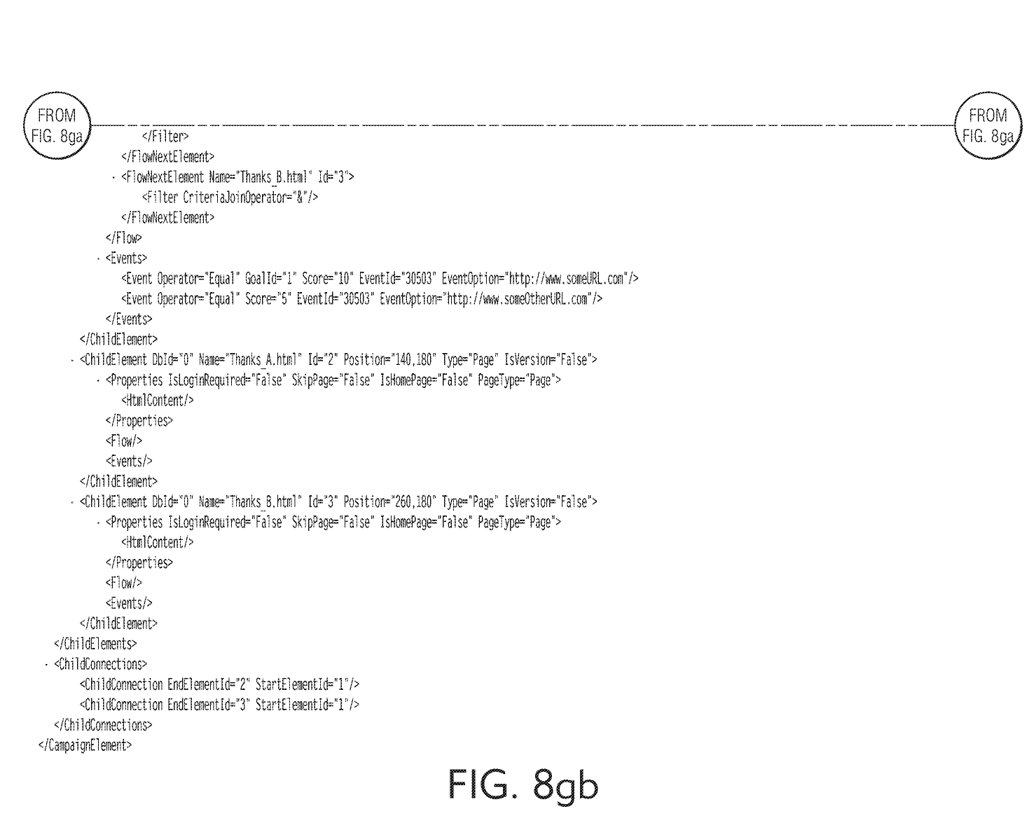

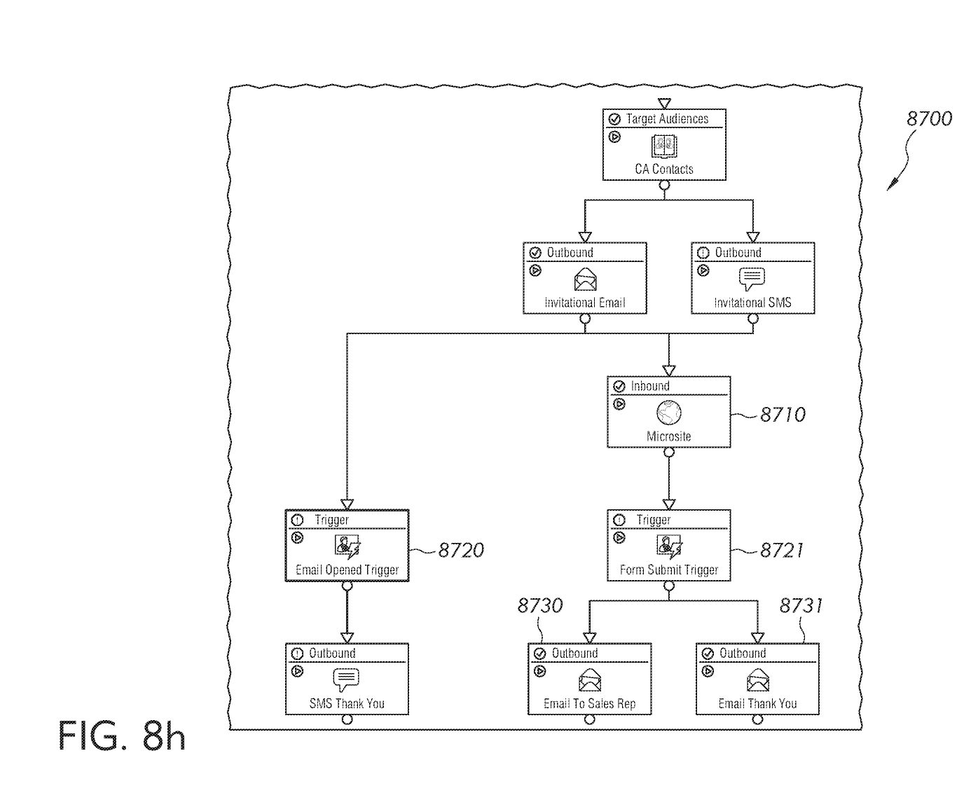

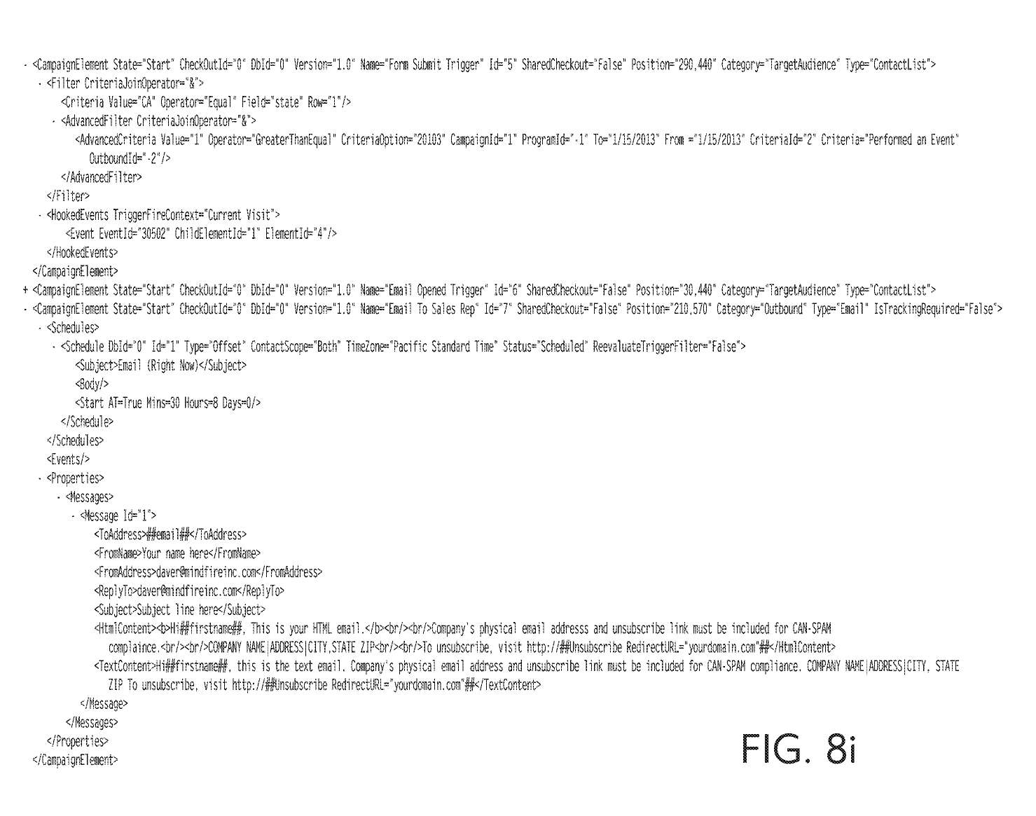

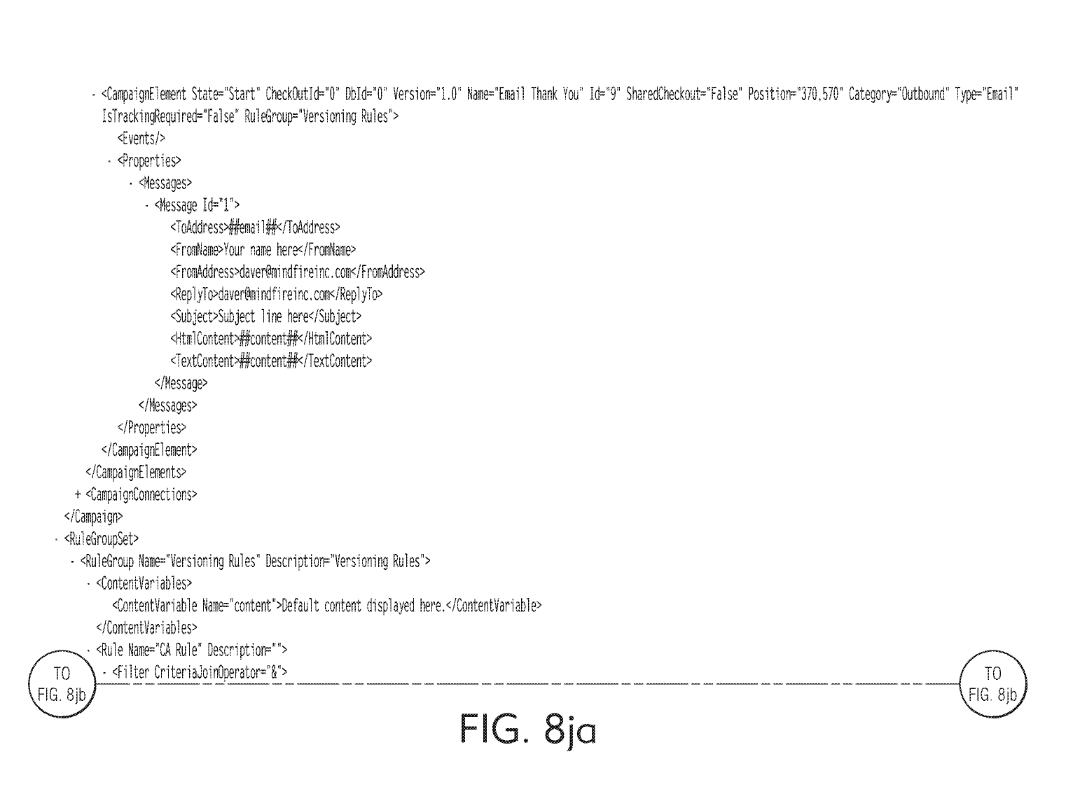

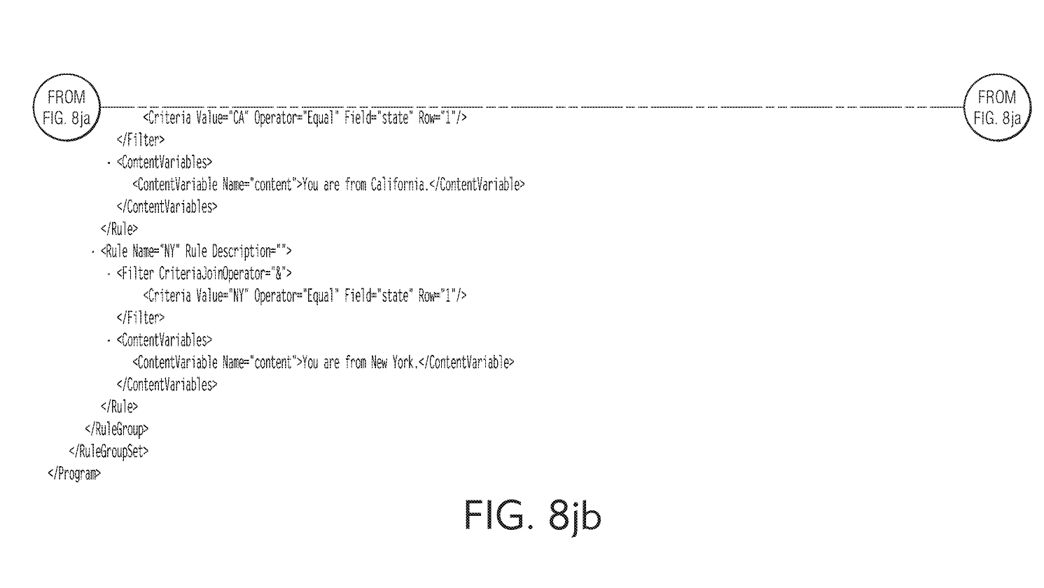

Turning to FIG. 8, an exemplary user interface 8000 on a user device 1200/1300 is shown. As the user creates a marketing campaign shown in window 8100 (same as campaign canvas 2300), XML is generated according to the user's workflow and Program Configuration 8200. To view the MAML program as shown in window 8200, the user selects the Program MAML tab 8300.

The MAML program comprises both execution instructions and content, e.g., Target Audiences, Outbounds, and Inbounds, of the marketing program. When the user executes, or launches, the saved marketing campaign, the marketing engine 1420 retrieves, parses, and processes the saved MAML program. The marketing engine 1420 comprises one or more application programming interfaces (API) to the technologies of the supported marketing media. For example, the marketing engine 1420 includes APIs for email, Twitter, Facebook, SMS, and so on. Because MAML is XML-based, the MAML program can interact with other XML-based programs, e.g., print workflow management software, customer relationship management (CRM) software, web-to-print software, and so on.

MAML is a portable language. A MAML program may be created by a system other than the marketing server system 1400, and/or without using the marketing engine 1420. Such MAML program then can be uploaded to the marketing server system 1400 and executed by the marketing engine 1420. It is also noted that MAML may also be used for applications other than marketing campaigns. Besides being portable, MAML is generally self-described; media-agnostic, which allows every marketing element to be defined in one of the three categories (Target Audience, Inbound, Outbound); human-readable; used by all platform subsystems; acting as the central nervous system for all interactions; extendable, allowing the addition of new media as they evolve and are invented; extensible, enabling third parties to include tags to control UI rendering. MAML simplifies integration; enables offline experience; provides collaboration, which means that MAML allows multiple users to collaborate on one program; provides program-level permissions. MAML can be published (e.g., validated and saved on the marketing server system 1400) or non-published.

If the published marketing program needs to be edited, for example content needs to be modified or additional elements need to be added, the user can “check out” either the entire program, one of its campaigns, or a specific campaign element. If a program is checked out, then all of its component campaigns, and all their component elements are “locked” and cannot be modified by anyone except the user who performed the check out. The same is true for a program's campaign, or a campaign's element.

FIG. 8a shows a MAML for an exemplary blank canvas 2300. Every Marketing program begins with a <Program> tag, which includes the following attributes:
State: If a program state is “Stop” and gets published, no schedules from that point forward will be executed. If a program is in the “Start” state, all schedules will execute.
Name: The program's Name
DbId: If a program is published, the Engine populates this attribute with the program's database record ID.
CheckOutId: If a program is checked out, the Engine assigns a check out ID which is used during the check in process to verify the checkout is valid and to store revision history, and the Studio uses it to make editing available in the program and all its elements.

FIGS. 8c-8e show the MAML for the exemplary multi-channel marketing workflow 8500 shown in FIG. 8b. In the MAML shown in FIG. 8c, the <CampaignElements> tag contains nine elements, each with a unique Id for this campaign. In the <CampaignConnections> tag, elements are related (as connected in the workflow 8500), referencing the element's Id. For example, the Target Audience element 8510 (Id 1) is connected to both the Invitational Email 8520 (Id 2) and the Invitational SMS 8521 (Id 3), showing that the Target Audience 8510, as defined in the “CA Contacts” Settings, will be touched by both the personalized Email and SMS.

In the MAML shown in FIG. 8d, in the Target Audience element 8510 “CA Contacts”, a segment is defined using filter criteria, using both standard contact fields and a contact's behavioral data.

In the MAML shown in FIG. 8e, in the Email element “Invitational Email” 8520, information related to schedules, events, and Properties (like any other element) are defined. The Schedules section includes information about when this Outbound is executed, and each schedule is tied to one or more connected Target Audiences. In the Events section, if the specified event(s) are triggered by a contact's behavior, the associated Cost, Goal, or Score is assigned to the contact. In the Properties section, there is a content area, which may include variables, including contact variables (like ##firstname## that are replaced with the contact's first name during execution), system variables (like an opt-out link, or an Inbound Touchpoint that leads the contact to an Inbound), content variables, and so on. Each Outbound element follows the same format.

FIG. 8g shows the MAML for the exemplary Microsite subworkflow 8600 shown in FIG. 8f. The Microsite subworkflow 8600 shows a page “Welcome” 8610 that directs the contact to one of two Thank You page versions (A or B) 8620, 8621, based on Flow criteria set on the Welcome Page 8610. The Welcome Page 8610 has been secured, which means that contacts must first successfully log in (using the Login.html page 8630) before continuing.

In the <CallbackTouchPoints> section, a URL is listed that describes how contacts can get to the Microsite. Any connected Outbound will display this Touch Point in order to allow contacts to arrive at the Microsite. In the <BaseURLCollection> section, this portion tells the marketing engine 1420 to provision this Microsite under the listed domain(s), and ensure that the domains are not used by any other Microsite. In the <ChildElements> section, each page of the Microsite is listed. In the <ChildConnections> tag, the child elements are defined to be related (as connected on the subworkflow 8600), referencing the child element's Id. For example, the Page “Welcome.html” 8610 (Id 1) is connected to ID 2 and ID 3. Inside <ChildElement>s, the first portion is the child element's content, followed by Form schema (including how form options are goaled, scored, and costed, and the validation required for the form, performed by the Microsite), followed by the Flow (optional), which describes how contacts move from a page to the appropriate next page based on certain conditions, as described in the Flow Filter. As with any other element, child elements may also have events.

FIGS. 8i-8j show the MAML for the exemplary workflow 8700 shown in FIG. 8h. The exemplary workflow 8700 includes connected Trigger 8720, 8721. The Trigger 8721 monitors the behavior of a contact in a connected element, which in this example is a Microsite 8710. In this example, the Trigger 8721 is hooked to the form submit event in the Microsite 8710. When this event occurs, the Outbounds beneath the Trigger 8721 are sent according to their configuration.

In FIG. 8i, in the CampaignElement Name “Form Submit Trigger”, the hooked events are articulated, as well as filter criteria that specify which segment of contacts the trigger should fire for. In the connected Outbound “Email to Sales Rep” 8730, everything is the same as any Outbound except for the schedule, which when in the triggered position, supports the ability to set an offset “wait” period before executing.

In FIG. 8j, in the <RuleGroupSet>, a RuleGroup named “Versioning Rules” is displayed. RuleGroups are defined at the program level, and can be used within any of its associated campaign elements. In this case, the rule is used in the campaign “Email Thank You” 8731, which allows the Email's content to be versioned based on whether the contact is from CA or NY. Depending on the contact's value for their state, the ##content## variable is replaced with the appropriate content during execution.

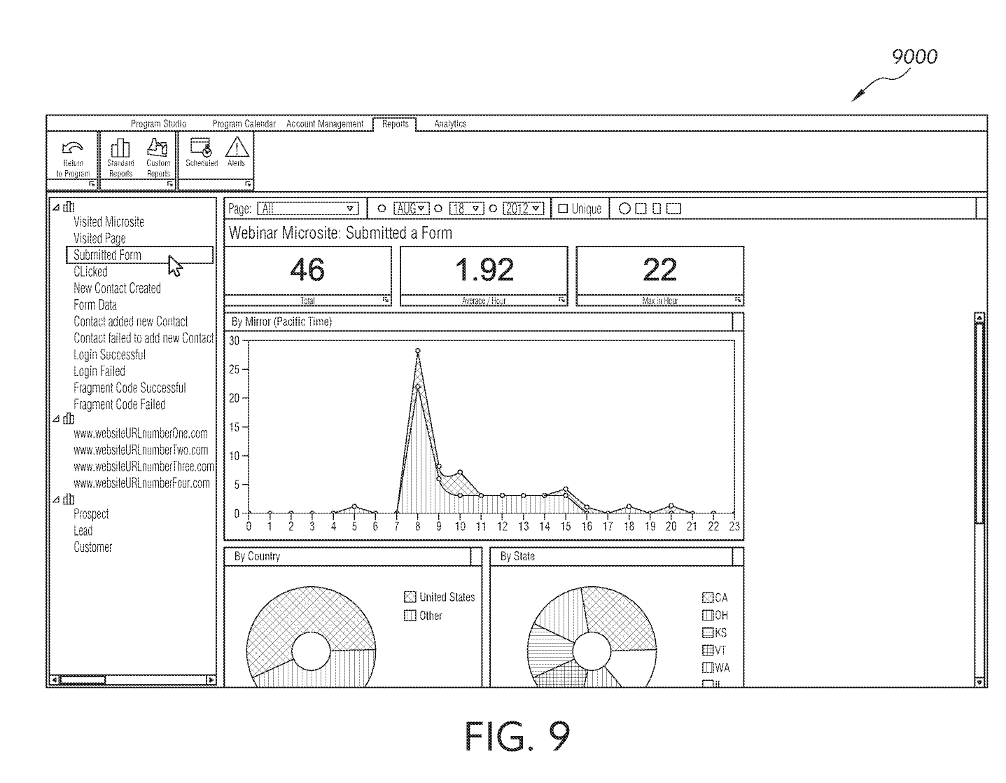

Turning to FIG. 9 an exemplary user interface 9000 on a user device 1200/1300 is shown. The marketing engine 1420 measures different aspects of the marketing campaign. Reporting exposes metrics related to an element's events, event Details, and Goals, Score, and Cost grouped by different dimensions. These dimensions include time, city, country, state, environmental variables like browser type, Inbound, Outbound, Target Audience, and so on. The measurements are stored in the campaign database 1450. The reports may be generated for each element of a marketing campaign. For example, the measurements are displayed as shown in the user interface 9000 when the user selects a marketing element and the Reports command icon in the Tool bar 2400/3100. The Reports command icon is available after a marketing campaign has been published. These measurements and reports help the user to understand the parts of the marketing campaign that have worked well and the parts that may not have worked as well.

### Preferred Processes

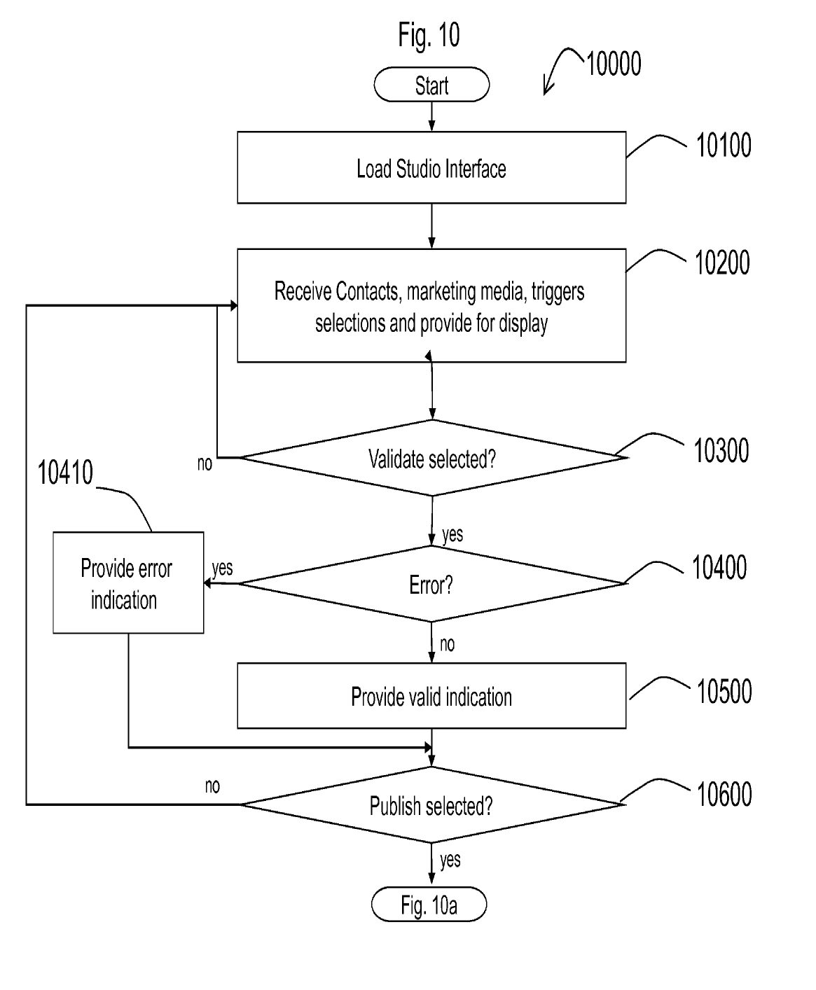

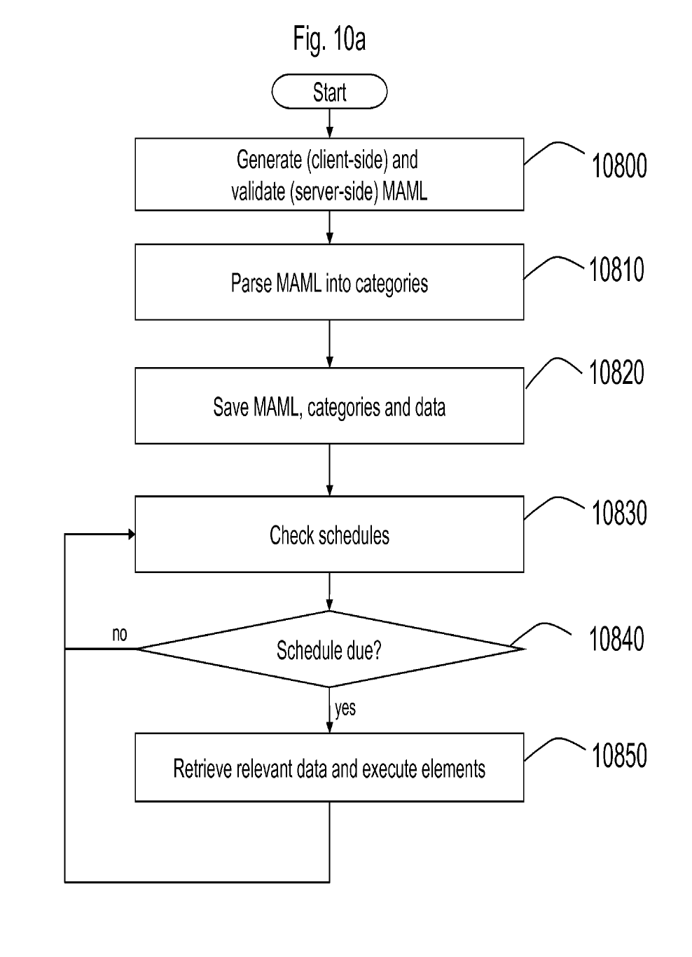

Turning to FIGS. 10 and 10a, according to an embodiment, a description of the operation 10000 of the marketing server system 1400 is shown. Generally, as mentioned above, a user will rely on the marketing server system 1400 and the marketing engine 1420 to design, orchestrate and manage multi-channel, multi-touch campaigns from one common interface.

Upon a user's launching the marketing studio 1430, the common user interface 2000 is loaded (Action Block 10100) to enable the user to design and create a marketing campaign. As shown in FIGS. 2 to 7 above, the marketing studio 1430 enables the user to select and define one or more contact lists, one or more Outbound media, one or more Inbound media, and/or triggers for the marketing campaign, and to author a marketing program workflow. As the user makes the selections and drags the selections to the campaign canvas 2300, the marketing studio 1430 receives and provides the selections for display (Action Block 10200). At any time, the user may also select to validate one or more elements of the marketing campaign (Decision Block 10300). If the marketing studio 1430 finds any error during the validation process (Action Block 10400), it provides an error indication in the one or more elements with the error (Action Block 10410). If no error is found, it provides a valid indication in the one or more elements with no error (Action Block 10500). At this time, the user may decide whether to publish the marketing campaign (Decision Block 10600). If the Publish command is selected, the marketing program's MAML is submitted to the marketing engine's 1420, which performs server-side validation and accepts the MAML (FIG. 10a, Action Block 10800). For example, the marketing engine 1420 checks to ensure that a domain associated with a Microsite is uniquely associated, and so on. Once the MAML is validated, the marketing engine's 1420 MAML parser parses the MAML into the three categories (Action Block 10810), and persists into the Account database 1450 (Action Block 10820). The marketing engine 1420 checks each element's schedule (Action Block 10830), and if any schedule is due (Decision Block 10840), the marketing engine 1420 attempts to execute that element according to the configuration of that element (Action Block 10850). During the execution, the marketing engine 1420 personalizes content, retrieves the relevant contact behavior, and some additional information, to provide it to the plugin to use this information and the associated contact data to execute that element. Certain Outbound elements may be executed in the cloud via an App. If any App is associated with an element, then the App performs the execution in the cloud.

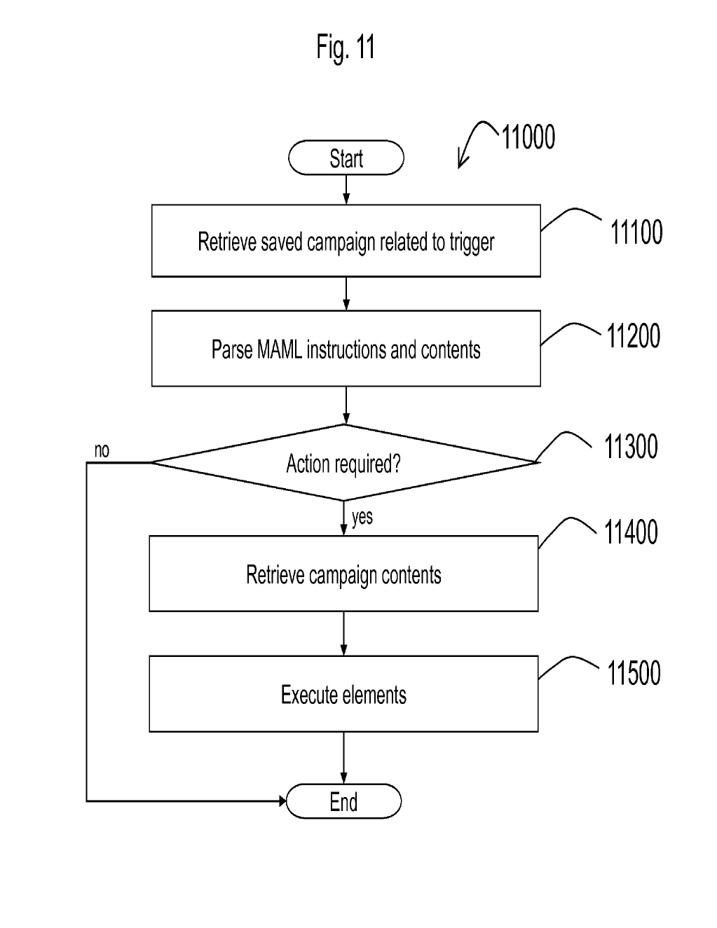

Turning to FIG. 11, according to an embodiment, a description of the operation 11000 of the marketing engine 1420 of the marketing server system 1400 is shown. When an Inbound event is received at the marketing server system 1400 and which is related to a defined trigger, the marketing engine 1420 retrieves the saved marketing campaign related to the trigger from the campaign database 1450 (Action Block 11100). As mentioned above, marketing campaigns are saved to the Campaign database 1450 in MAML. The marketing engine's 1420 MAML parser then parses the MAML instructions and content of the retrieved marketing campaign (Action Block 11200). If the trigger event required one or more actions (Decision Block 12300), the marketing engine 1420 retrieves one or more campaign content specified in MAML (Action Block 11400) from the Campaign database 1450 and/or the Contact Repository 1451, and executes the relevant elements (Action Block 11500).

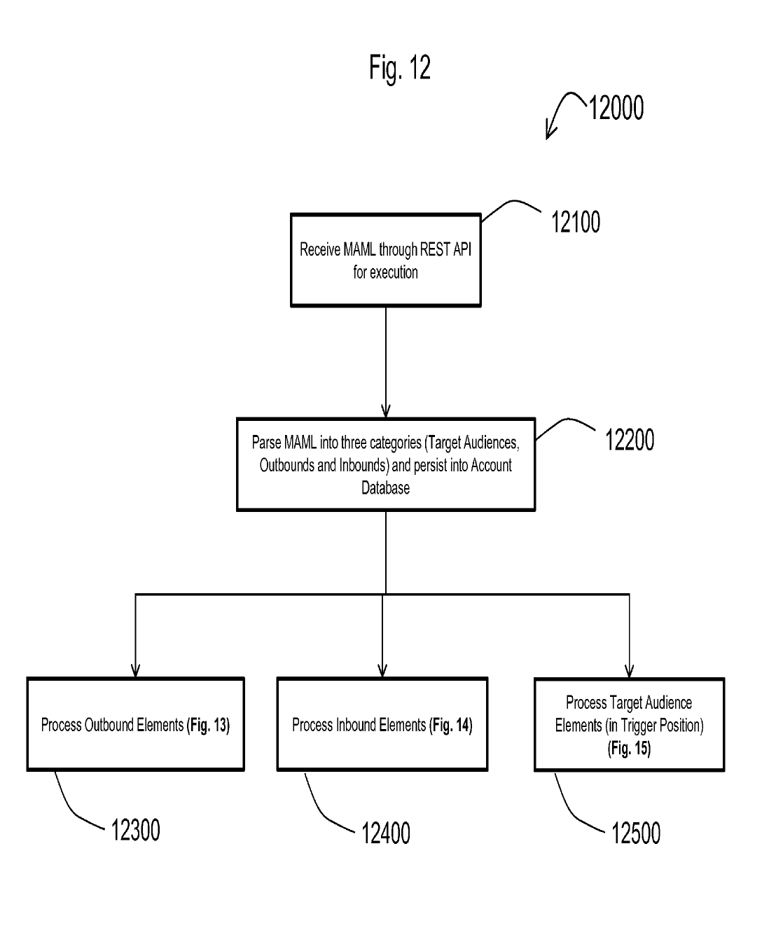

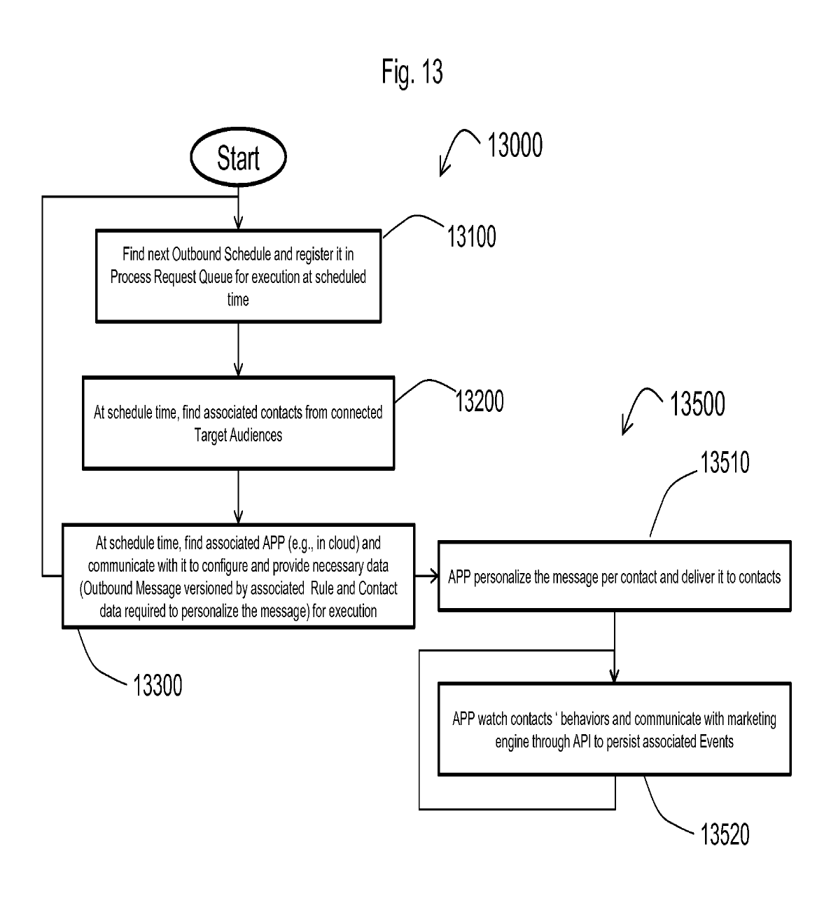

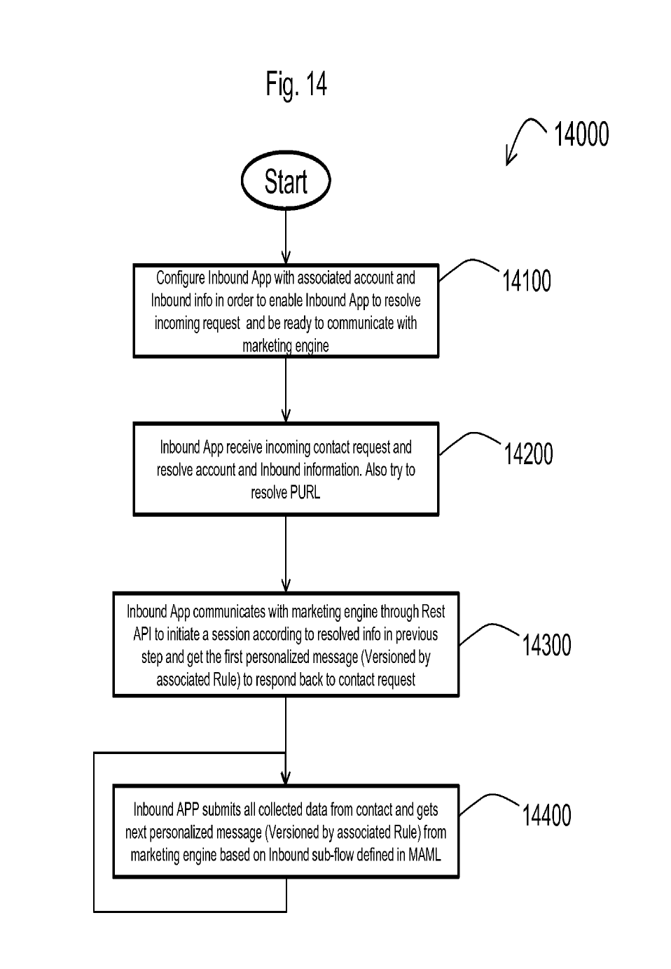

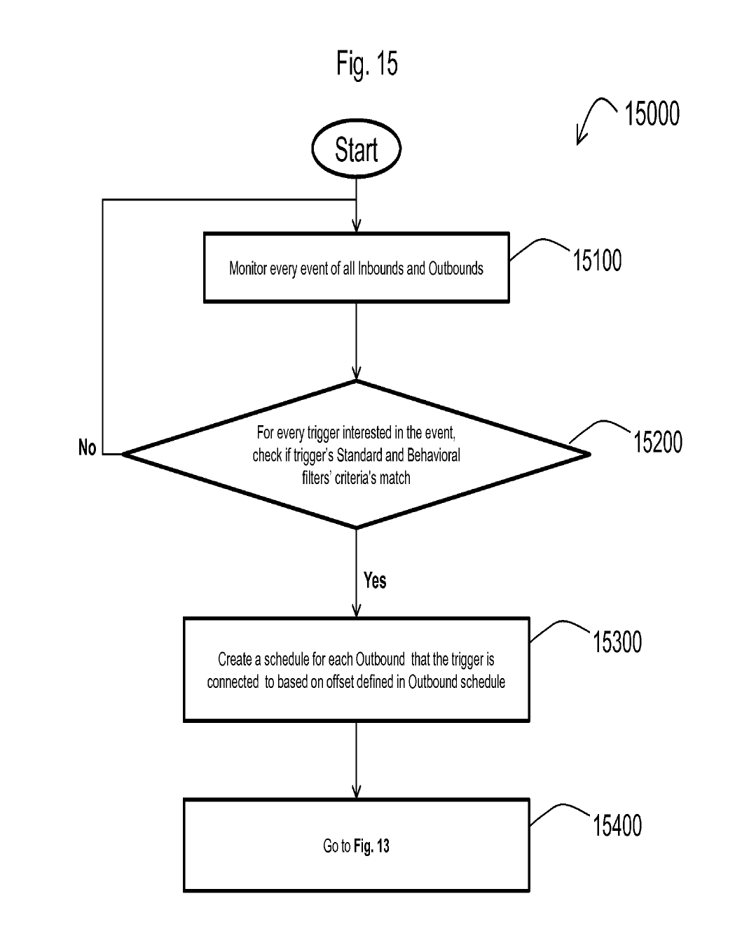

Turning to FIG. 12, according to an embodiment, a description of the operation 12000 of the marketing engine 1420 of the marketing server system 1400 is shown. After a marketing campaign has been published, the marketing engine 1420 receives the MAML through a REST API for execution (Action Block 12100). The marketing engine's 1420 MAML parser parses the MAML into the three categories (Target Audiences, Outbounds and Inbounds), and persists into the Account database 1450 (Action Block 12200). The marketing engine 1420 is now ready to execute Outbound elements (Action Block 12300, see also FIG. 13), Inbound elements (Action Block 12400, see also FIG. 14), and Target Audience elements (via triggers) (Action Block 12500, see also FIG. 15).

Turning to FIG. 13, according to an embodiment, a description of the Outbound processing operation 13000 of the marketing engine 1420 of the marketing server system 1400, as well as the operation 13500 of an app are shown. The marketing engine 1420 finds one or more Outbound schedules and register it in a process request queue for execution at the scheduled time (Action Block 13100). At the scheduled time of an Outbound schedule, the marketing engine 1420 finds one or more associated contacts from connected Target Audiences (Action Block 13200). Also at the scheduled time, the marketing engine 1420 finds one or more App (which may be cloud based), communicates with the App to configure and provide necessary data (e.g., Outbound message versioned by associated rule and contact data required to personalize the message, and so on) for execution (Action Block 13300). The marketing engine 1420 continues to find one or more Outbound schedules (Action Block 13100).

Turning to operation 13500 of an App to which the marketing engine 1420 communicates (Action Block 13300), the App personalizes the message per contact and delivers it one or more contacts (Action Block 13510). The App then continues to watch the contacts' behaviors and communicates with the marketing engine 1420 through API to persist one or more associated events (Action Block 13520).

Turning to FIG. 14, according to an embodiment, a description of the Inbound processing operation 14000 of the marketing engine 1420 of the marketing server system 1400 is shown. The marketing engine 1420 configures one or more Inbound Apps with associated account and Inbound info in order to enable Inbound App to resolve one or more incoming requests and be ready to communicate with the marketing engine 1420 (Action Block 14100). The Inbound App receives one or more incoming contact requests and resolve account and Inbound information. The Inbound App also tries to resolve any persistent URL (PURL) (Action Block 14200). The Inbound App communicates with the marketing engine 1420 through REST API to initiate a session according to resolved information in the previous step and get the first personalized message (versioned by associated rule) to respond back to the contact request (Action Block 14300). The Inbound App then continues to submit all collected data from the contact and gets next personalized message (Versioned by associated Rule) from the marketing engine 1420 based on Inbound sub-flow defined in the MAML (Action Block 14400).

Turning to FIG. 15, according to an embodiment, a description of the trigger processing operation 15000 of the marketing engine 1420 of the marketing server system 1400 is shown. The marketing engine 1420 monitors every event of all Inbound and Outbound elements (Action Block 15100). For every trigger interested in the event, the marketing engine 1420 checks if the trigger's Standard and Behavioral filters' criteria's match with the event (Decision Block 15200). If matched, the marketing engine 1420 creates a schedule for each Outbound element that the trigger is connected to, based on offset defined in Outbound schedule (Action Block 15300). The marketing engine 1420 then continues with the Outbound processing operation 13000 (Action Block 15400, see also FIG. 13).

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. Additionally and obviously, features may be added or subtracted as desired. Accordingly, the invention is not to be restricted except in light of the attached claims and their equivalents.

What is claimed is:

1. A computer-based system for designing, creating, and executing a multi-channel, multi-touch marketing campaign using, an electronic extensible markup language comprising:
a marketing server system, operatively coupled to a plurality of electronic data communication channels, including at least electronic mail and microsites, having a database that stores contacts data associated with a plurality of marketing contacts, and marketing campaign data, wherein the marketing server system is programmed to:
provide a graphical user interface for display at a user's device that displays the plurality of data communication channels as electronic objects having a set of properties and that enables a user to design an automated campaign workflow by graphically manipulating the electronic objects and their respective properties, wherein the electronic object associated with electronic mail includes a property that associates the electronic mail object to the contacts data and a property that includes Hypertext Markup Language data for that electronic mail object, and wherein the electronic object associated with a microsite includes Hypertext Markup Language data;
generate an electronic extensible markup language file in accordance with the user's automated campaign workflow design that defines electronic data to be distributed based at least in part on a schedule and data communication channel; and
transmit the electronic data via the data communication channels in accordance with the electronic extensible markup language file.

2. The computer-based system of claim 1, wherein the marketing server system checks for due schedules in the, electronic extensible markup language file, retrieve elements and data and execute the scheduled elements.

3. The computer-based system of claim 1, wherein the marketing server system is further programmed to:
retrieve marketing contacts from the database that stores contacts data; and
transmit electronic data to said marketing contacts via the data communication channels.
